(19) United States
(12) Patent Application Publication
(10) Pub. No.: US 2026/0116082 A1
(43) Pub. Date: Apr. 30, 2026

(54) STIRRING APPARATUS

(71) Applicant: CANON KABUSHIKI KAISHA, Tokyo (JP)

(72) Inventors: KENTA IIMURA, Tokyo (JP); HIROMASA YONEYAMA, Kanagawa (JP); MASAKAZU NAGASHIMA, Kanagawa (JP); YUJIRO ISHIDA, Tokyo (JP); RYOHEI MARUYAMA, Kanagawa (JP); RYUTARO TAKAHASHI, Tokyo (JP); SHU KURIHARA, Tokyo (JP); KEIICHI KITANO, Kanagawa (JP); TAKAYA SATO, Tokyo (JP); KANTO KURASAWA, Tokyo (JP)

(21) Appl. No.: 19/363,540

(22) Filed: Oct. 20, 2025

(30) Foreign Application Priority Data
Oct. 28, 2024 (JP) 2024-189200
Oct. 31, 2024 (JP) 2024-192417

(51) Int. Cl. B41J 2/20; B01F 29/30; B01F 31/31; B01F 35/221; B01F 101/35; B41J 2/175; B41J 3/44

(52) U.S. Cl. CPC B41J 2/20; B01F 29/30; B01F 31/31; B01F 35/22161; B41J 2/17513; B41J 2/17553; B41J 3/44; B01F 2101/35; B41J 2002/17516

(57) ABSTRACT

A stirring apparatus includes a storage portion configured to store a container, a stirring unit configured to perform a stirring operation for the container stored in the storage portion such that a liquid contained in the container is stirred, a regulating unit whose state changes between a regulating state in which extraction of the container from the storage portion is regulated and a regulation cancel state, and a control unit.

The control unit interrupts the stirring operation upon determining that the state of the regulating unit changes from the regulating state to the regulation cancel state during the stirring operation, and resumes the stirring operation upon determining that the state of the regulating unit changes from the regulation cancel state to the regulating state during the interruption of the stirring operation.

### BACKGROUND

### Field of the Technology

The present disclosure relates to a stirring apparatus.

### Description of the Related Art

In some cases, a liquid containing a substance with sedimentability needs to be stirred to dispersion a sediment at the time of use. For example, in a printing apparatus that performs printing by discharging liquid ink to a print medium, when using ink such as pigment ink or metallic ink, the stirring may be needed to disperse a sediment. Japanese Patent Laid-Open No. 2018-1443 discloses an apparatus that presses a liquid container containing ink, thereby stirring the contained ink.

If an operation associated with detachment of the liquid container is performed during the stirring operation, and the stirring operation is continued, it is difficult to detach the liquid container. If the stirring operation is interrupted, stirring of the liquid in the liquid container is insufficient. If the insufficiently stirred liquid is used for printing, printing quality may be low.

### SUMMARY

The present disclosure provides a technique characterized in control associated with a stirring operation and detachment of a container.

According to one aspect of the present disclosure, there is provided a stirring apparatus comprising: a storage portion configured to store a container; a stirring unit configured to perform a stirring operation for the container stored in the storage portion such that a liquid contained in the container is stirred; a regulating unit whose state changes between a regulating state in which extraction of the container from the storage portion is regulated and a regulation cancel state; and a control unit configured to control the stirring unit, wherein the control unit is configured to: interrupt the stirring operation upon determining that the state of the regulating unit changes from the regulating state to the regulation cancel state during the stirring operation, and resume the stirring operation upon determining that the state of the regulating unit changes from the regulation cancel state to the regulating state during the interruption of the stirring operation.

Features of the present disclosure will become apparent from the following description of embodiments with reference to the attached drawings. The following description of embodiments are described by way of example.

### BRIEF DESCRIPTION OF THE DRAWINGS

FIG. 1 is a perspective view of a system according to an embodiment;

FIG. 2 is a front view of the system shown in FIG. 1;

FIG. 3 is an explanatory view of the internal structure of a liquid discharge apparatus;

FIG. 4 is a partially exploded perspective view of a liquid supply apparatus;

FIG. 5 is a perspective view of a liquid container and a support unit;

FIG. 6 is an operation explanatory view of a handle and a regulating mechanism;

FIG. 7 is an operation explanatory view of the regulating mechanism;

FIG. 8 is a view showing the attachment posture and the insertion/removal mode of the support unit for a storage portion;

FIG. 9 is an operation explanatory view of a stirring unit;

FIG. 10 is an operation explanatory view of the stirring unit;

FIG. 11 is an explanatory view of a cam;

FIG. 12 is a perspective view of a case with a stirring function and the support unit in a separated state;

FIG. 13 is a perspective view of the case with the stirring function and the support unit in an attached state;

FIG. 14 is an explanatory view of a stirring operation;

FIG. 15 is an explanatory view of the stirring operation;

FIG. 16 is a front view of a storage portion having a box shape;

FIG. 17 is a perspective view of the liquid container and the support unit;

FIG. 18 is a perspective view of the stirring unit;

FIG. 19 is a perspective view of the stirring unit;

FIG. 20 is a front view of a container space;

FIG. 21 is a view showing the containing mode of a container support unit;

FIG. 22 is a front view of the stirring unit;

FIG. 23 is a perspective view of the rear portion of the stirring unit;

FIG. 24 is a view showing an example of the stirring operation;

FIG. 25 is a block diagram of the control circuit of the system shown in FIG. 1;

FIG. 26 is a flowchart showing an example of control;

FIG. 27 is a flowchart showing an example of control;

FIGS. 28A and 28B are flowcharts showing an example of control;

FIG. 29 is a flowchart showing an example of control;

FIGS. 30A and 30B are views showing an example of display on an operation panel;

FIG. 31A is a flowchart showing an example of control;

FIG. 31B is a view showing an example of display on an operation panel;

FIG. 32A is a flowchart showing an example of control;

FIG. 32B is a view showing an example of display on an operation panel;

FIG. 33A is a flowchart showing an example of control;

FIG. 33B is a view showing an example of display on an operation panel;

FIG. 34A is an explanatory view of a lock mechanism;

FIG. 34B is a flowchart showing an example of control;

FIG. 35 is a perspective view of the system shown in FIG. 1, which shows an example of the arrangement of a sensor;

FIG. 36 is a perspective view of the system shown in FIG. 1, which shows an example of the arrangement of a sensor;

FIG. 37 is a flowchart showing an example of control;

FIG. 38 is a view showing an example of control contents in stirring regulation processing; and

FIGS. 39A and 39B are views showing an example of control contents in stirring regulation processing.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

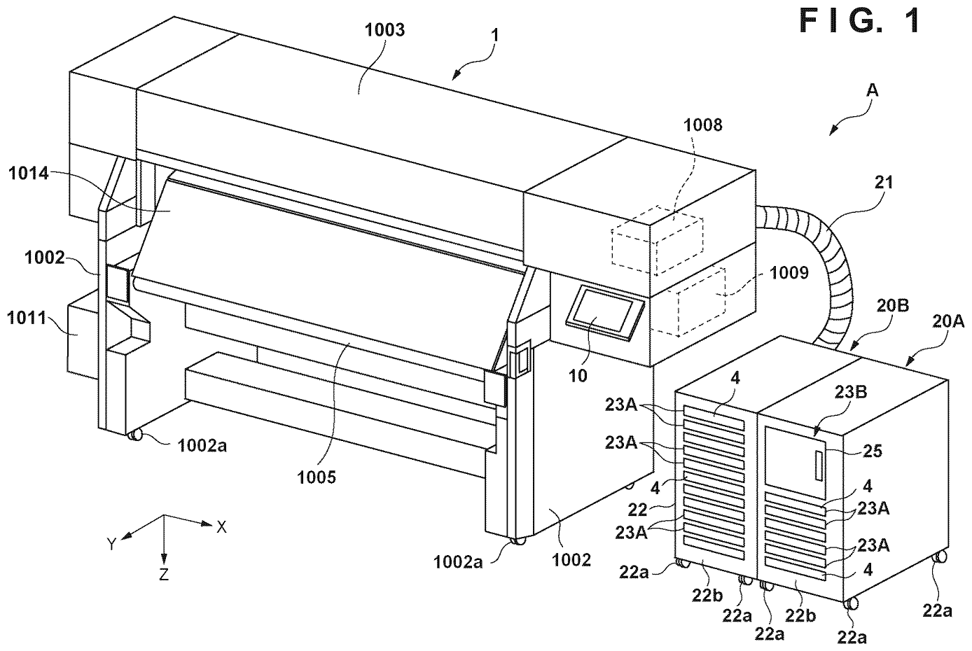

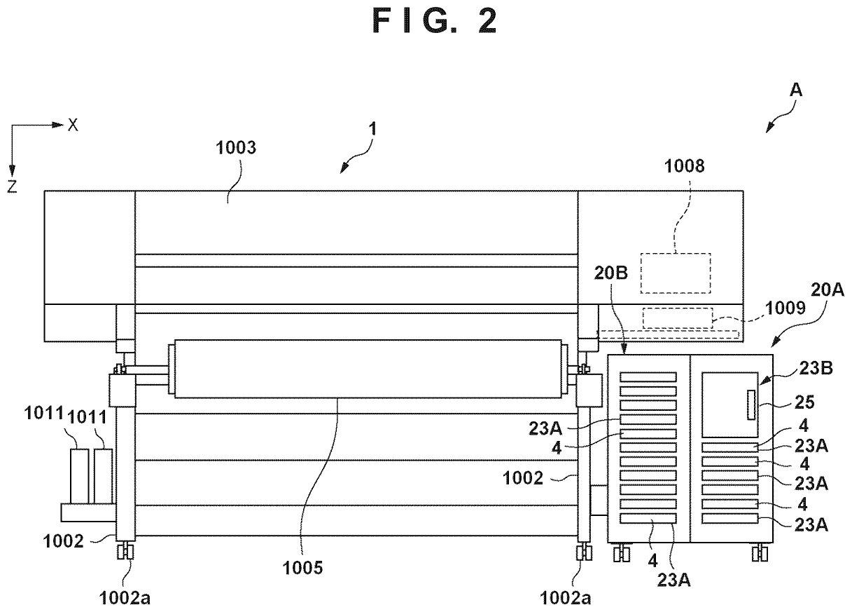

FIG. 1 is a perspective view of a system A according to an embodiment, and FIG. 2 is a front view of the system A. In the drawings, arrows X, Y, and Z indicate directions crossing each other, and in this embodiment, the directions are orthogonal to each other. The left/right direction in a case where the system A is installed on a horizontal surface is the X direction, the front/back direction is the Y direction, and the up/down direction is the Z direction. In addition, the right side of the system A viewed from front is as the +X direction, the left side is the −X direction, the near side is the +Y direction, the far side is the −Y direction, the lower side (downward in the gravity direction) is the +Z direction, and the upper side (upward in the gravity direction) is the −Z direction.

The system A according to this embodiment is a printing system that includes a liquid discharge apparatus 1 and liquid supply apparatuses 20A and 20B and prints an image by discharging ink to a print medium such as paper. In this embodiment, two liquid supply apparatuses 20A and 20B are provided. The liquid supply apparatuses 20A and 20B will sometimes be referred to as liquid supply apparatuses 20 without distinction or generically. The liquid discharge apparatus 1 and the two liquid supply apparatuses 20A and 20B are arranged side by side in the X direction. A liquid that the liquid supply apparatuses 20A and 20B supply to the liquid discharge apparatus 1 is mainly ink, and the liquid discharge apparatus 1 is a printing apparatus that discharges the ink to the print medium. However, the present disclosure is not limited to the printing system, and can also be applied to various kinds of liquid discharge systems aiming at discharging a liquid to a medium.

Note that “printing” is not limited to formation of significant information such as a character or figure, and includes, in a broad sense, to form an image, design, pattern, or the like on a print medium or process a medium regardless of whether information is significant or insignificant, or whether information is so visualized as to allow a person to visually perceive it. Also, in this embodiment, the “print medium” is assumed to be sheet-shaped paper but may be a cloth, a plastic film, or the like.

### Liquid Discharge Apparatus

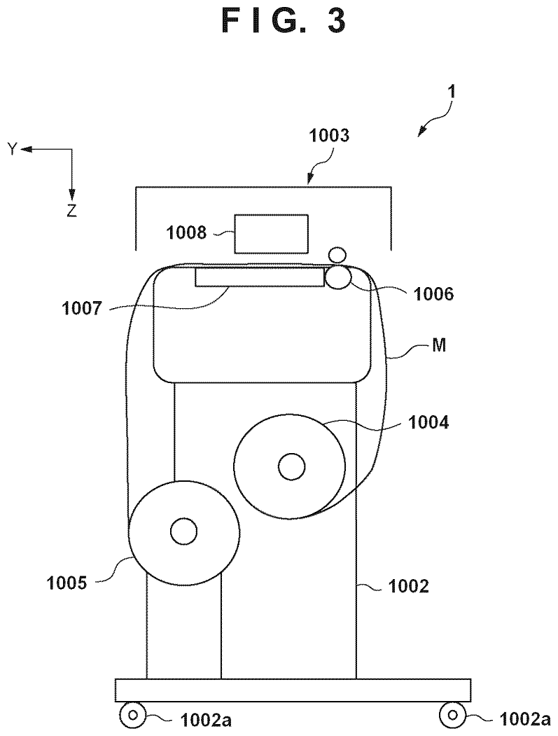

The liquid discharge apparatus 1 will be described with reference to FIG. 3 in addition to FIGS. 1 and 2. FIG. 3 is an explanatory view of the internal structure of the liquid discharge apparatus 1. The liquid discharge apparatus 1 includes a pair of left and right stands 1002, and a main body 1003 supported on the pair of stands 1002. Each stand 1002 is provided with casters 1002a, and the liquid discharge apparatus 1 can be relatively easily moved on the floor. A feeding unit 1004, a drying unit 1014, and a winding unit 1005 are arranged under the main body 1003. In this embodiment, a print medium M is roll paper, and the feeding unit 1004 includes a shaft on which the print medium M is wound. The winding unit 1005 includes a shaft for winding up the print medium M. In this embodiment, roll paper has been exemplified as the print medium M, but it may be cut paper.

A conveyance unit 1006 is provided in the main body 1003. The conveyance unit 1006 includes a driving roller and a driven roller, and the print medium M fed from the feeding unit 1004 is sandwiched in the nip portion between the rollers. When the driving roller rotates, the print medium M is conveyed onto a platen 1007. A discharge head 1008 is arranged facing the platen 1007. The discharge head 1008 is a printhead that discharges ink to form an image. The discharge head 1008 discharges the ink to the print medium M conveyed onto the platen 1007, thereby forming an image on the print medium M.

The discharge head 1008 includes, for example, a discharge energy generation element such as an electrothermal transducer (heater) or a piezoelectric element, and discharges ink from an orifice. If the electrothermal transducer is used, ink can be foamed by generated heat and discharged from the orifice using the foaming energy. The printing method of the discharge head 1008 can be a serial scan method or a full-line method. In a case of the serial scan method, the discharge head 1008 is mounted on a carriage and reciprocally moved in the X direction. Discharging ink while moving the discharge head 1008 in the X direction is called print scanning. The conveyance operation of the print medium M and print scanning of the discharge head 1008 are alternately repeated, thereby printing an image on the print medium M. In this embodiment, employment of the serial scan method is assumed. In a case of the full-line method, a long discharge head extending in the X direction is used, and an image is printed while continuously conveying the print medium M.

The print medium M with the image printed thereon passes through the drying unit 1014 and is then wound up by the winding unit 1005. The drying unit 1014 reduces liquid components contained in the ink applied, by the discharge head 1008, to the print medium M, thereby increasing the fixing properties between the print medium M and the ink. The drying unit 1014 includes a heat source such as a heater, and a blower mechanism such as a fan, and applies hot air at least from the ink application surface side to the passing print medium M, thereby drying the print medium M. To increase the drying efficiency, the hot air may be applied not only to the ink application surface but also to the opposite side of the ink application surface. Note that as for the drying method, not only the method of applying hot air but also a method of irradiating the surface of the print medium M with an electromagnetic wave (ultraviolet rays or infrared rays) or a heat conduction method using contact of a heat generating body may be used in combination. In addition, the drying unit 1014 may only blow air without having any heat source. The print medium M with the image printed thereon is cut by a user using scissors or automatically cut by a cutter (not shown).

A recovery unit 1009 is arranged in the main body 1003. The recovery unit 1009 is arranged outside the print region (outside the discharge region) of the discharge head 1008, and performs processing associated with recovery and maintaining of the discharge performance of the discharge head 1008. Examples of the processing are preliminary discharge of discharging a predetermined amount of ink before and after a printing operation and processing of sucking remaining ink or the like from the orifices of the discharge head 1008. The discharge head 1008 is moved onto the recovery unit 1009, as shown in FIG. 2, if recovery processing is necessary.

An operation panel 10 is provided on the front surface of the main body 1003. Also, the operation panel 10 is, for example, a touch panel and can accept input of various kinds of settings concerning printing, display the state of a print job, or make a notification not the user. The operation panel 10 may be provided with a voice output device, and may make a notification to the user by display and voice. The liquid discharge apparatus 1 also includes a waste liquid cartridge 1011. The waste liquid cartridge 1011 is arranged under an end portion of the main body 1003 on the opposite side of the liquid supply apparatuses 20A and 20B in the X direction.

A waste liquid (waste ink or the like) sucked by the recovery unit 1009 flows into the waste liquid cartridge 1011 to be collected. The waste liquid cartridge 1011 may be arranged near the recovery unit 1009. In this embodiment, however, the waste liquid cartridge 1011 is arranged in a free space under the end portion of the main body 1003, thereby reducing the installation area of the liquid discharge apparatus 1.

### Liquid Supply Apparatus

FIGS. 1 and 2 will be referred to. The liquid supply apparatus 20 is an apparatus that stores a liquid such as ink to be discharged from the discharge head 1008 and supplies the liquid such as ink to the liquid discharge apparatus 1. Also, as will be described later, the liquid supply apparatus 20 has a stirring function of stirring the liquid, and functions as a stirring apparatus in this viewpoint. Each liquid supply apparatus 20 includes a box-shaped main body 22. The main body 22 of the liquid supply apparatus 20B forms a plurality of storage portions 23A, and the main body 22 of the liquid supply apparatus 20A form a plurality of storage portions 23A and one storage portion 23B. Casters 22a are provided on the bottom surface of the main body 22, and the liquid supply apparatuses 20 can be relatively easily moved on the floor.

The liquid supply apparatus 20 includes the plurality of storage portions 23A arrayed in the Z direction. Each storage portion 23A has a form of a slot opening to a front wall portion 22b of the main body 22. In each storage portion 23A, a support unit 4 is detachably inserted in the Y direction. The support unit 4 exchangeably supports a liquid container 200 (to be also simply referred to as a container 200) to be described later.

The liquid supply apparatus 20A includes the storage portion 23B. The storage portion 23B is a box-shaped storage portion that opens to the front wall portion 22b of the main body 22, has a space larger than the storage portion 23A, and is opened/closed by an opening/closing member 25 provided on the front wall portion 22b.

Each of the storage portions 23A and 23B is provided with a tube that connects the container 200 and the liquid discharge apparatus 1. Each tube is connected to the liquid discharge apparatus 1 through a single hose 21 that stores all tubes. Ink in the container 200 is supplied to the discharge head 1008 via the tube.

### Liquid Container and Support Unit

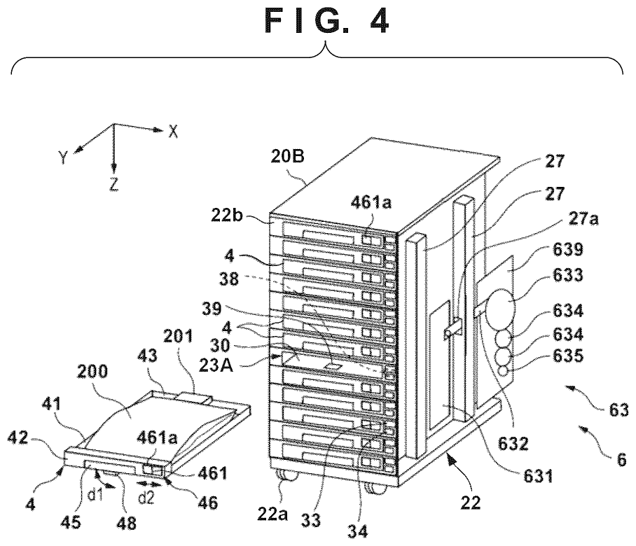

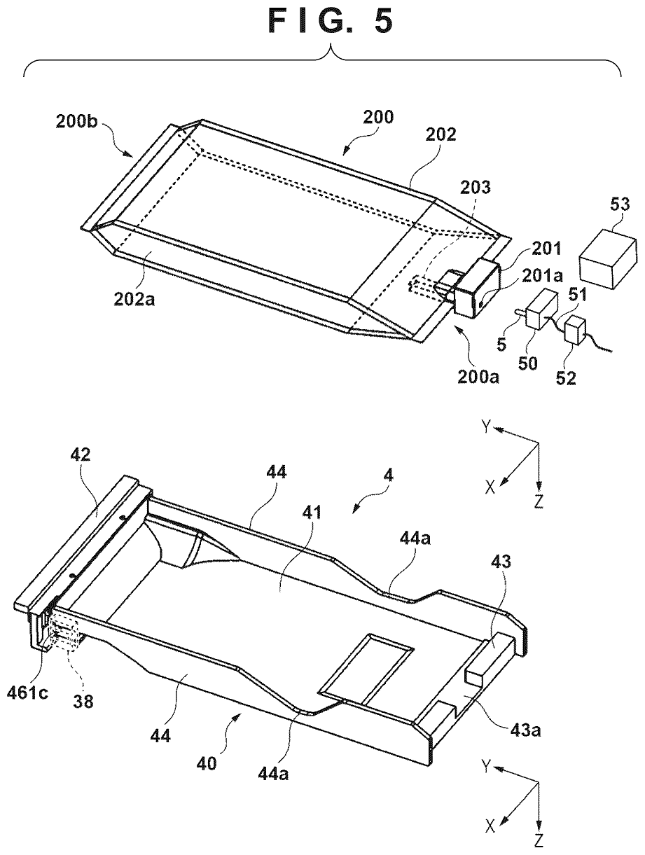

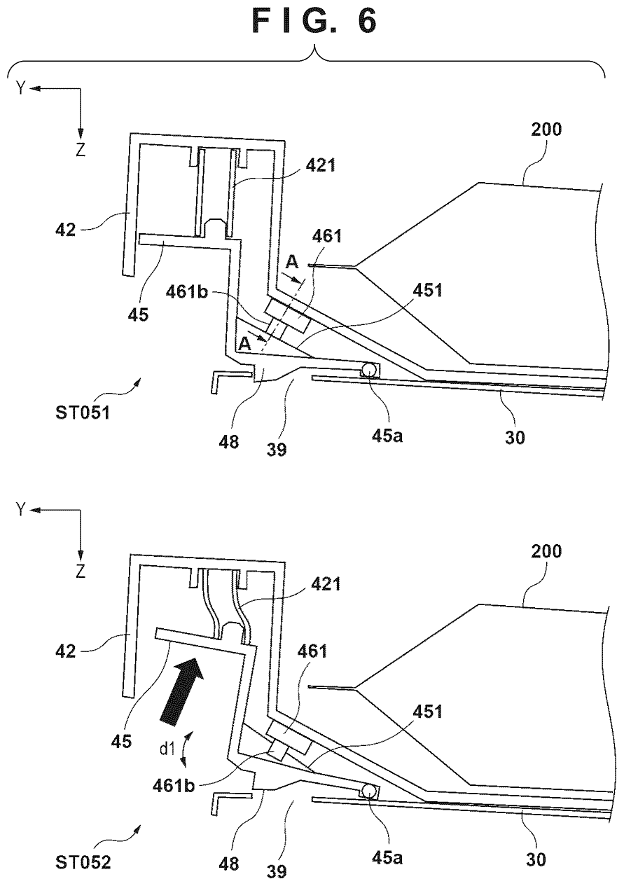

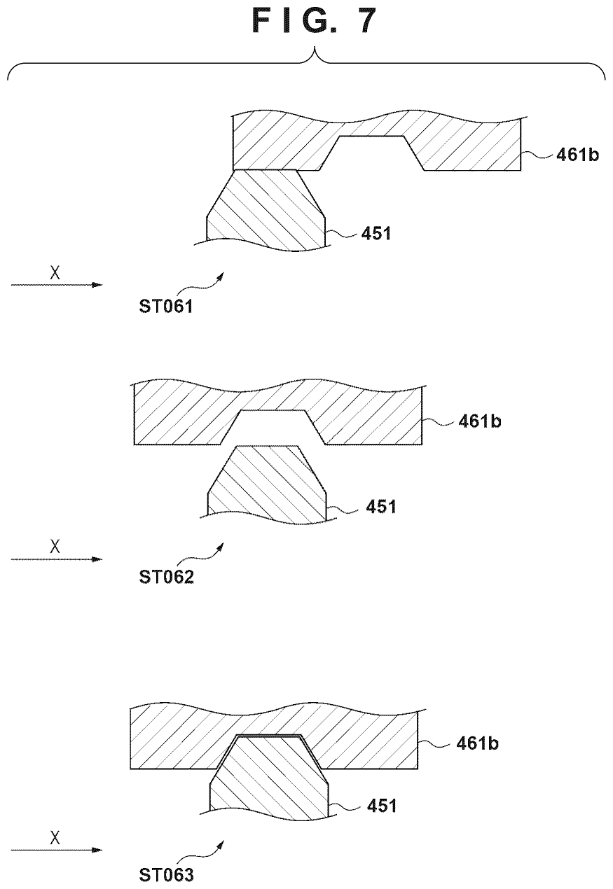

FIGS. 4 to 7 will be referred to. FIG. 4 is a partially exploded perspective view of the liquid supply apparatus 20B and shows a state in which one support unit 4 is detached from the corresponding storage portion 23A. Also, FIG. 4 shows a state in which of the outer wall portion of the liquid supply apparatus 20B, one side wall portion is detached to expose the internal mechanism. FIG. 5 is a perspective view of the liquid container 200 and the support unit 4. FIG. 6 is an operation explanatory view of a handle 45 and a regulating mechanism 46. FIG. 7 is an operation explanatory view of the regulating mechanism 46 and corresponds to a sectional view taken along a line A-A in FIG. 6.

The container 200 includes a bag-shaped container portion 202 made of a material with flexibility. Gusset portions 202a folded inside are provided on both side surfaces of the container portion 202 to increase the liquid containing amount. The container portion 202 is formed into a bag shape by welding sheets forming the upper and lower surfaces and sheets forming the gusset portions 202a to each other, thereby forming a flexible tank for containing a liquid. The shape of the container portion 202 changes in accordance with the contained liquid amount such that if the liquid amount remaining inside is large, the gusset portions 202a expand, and if the liquid amount remaining inside is small, the gusset portions 202a are folded inside. The material of the container portion 202 is, for example, a material having a multiple-layer structure such as PET. If the liquid inside has a property of reacting with air and sticking, or there is concern that the concentration or remaining amount changes due to evaporation, a layer material including an aluminum layer is advantageous as the material of the container portion 202.

The container 200 has one end portion 200a and the other end portion 200b in the longitudinal direction. In an attached state to the liquid supply apparatus 20, the end portion 200a is located on the far side of the liquid supply apparatus 20, and the end portion 200b is located on the near side. A connecting portion 201 is provided at the end portion 200a. The connecting portion 201 is provided with a memory that stores individual information of the liquid container 200. The individual information includes, for example, identification information for specifying each container 200 or type information and remaining amount information of the liquid contained in the container 200. A reader/writer 53 provided in the main body 22 in correspondence with each storage portion 23A reads/writes information from/to the memory by wireless communication.

In the connecting portion 201, a supply port 201a communicating with an intake port 203 inside the container portion 202 is formed. The liquid contained in the container portion 202 flows to the outside via the intake port 203 and the supply port 201a. A spring biased-type supply port control valve that opens/closes the supply port 201a is provided in the connecting portion 201. By the supply port control valve, the supply port 201a is maintained in the closed state normally (without application of an external force or the like).

In the container 200, the side provided with the connecting portion 201 has a length of, for example, about 180 mm, and the side (side surface) orthogonal to this side has a length of, for example, about 400 mm. In the container 200, for example, about 1.5 L liquid is stored. Note that the side with the connecting portion 201 may be not the short side but the long side. Also, the container portion 202 may have not a rectangular shape but a square shape in a planar view.

The main body 22 includes, on the far side of the storage portion 23A, a connecting unit 50 connected to the connecting portion 201. The connecting unit 50 includes a needle-type path forming member 5 inserted into the supply port 201a. The connecting unit 50 is provided for each storage portion 23A. If the path forming member 5 is inserted into the supply port 201a and connected, the supply port control valve is opened by the insertion of the path forming member 5. The path forming member 5 communicates with a tube 51. The path forming member 5 forms a path that flows the liquid contained in the container portion 202 to the liquid discharge apparatus 1 that is the supply destination, and the liquid flowed out to the path forming member 5 is supplied to the liquid discharge apparatus 1 via the tube 51. An electrically driven passage valve 52 is provided on a midway part of the tube 51. The tube 51 can be closed and opened by opening/closing of the passage valve 52.

The support unit 4 includes a support portion 40 that supports the container 200, and has a form of a tray on which the container 200 in a lying posture is placed on the whole. The support unit 4 can be displaced substantially in the Y direction between a storage position where the container 200 is stored in the main body 22 and an extraction position where the container 200 is exposed to the outside of the main body 22. In FIG. 4, one support unit 4 is located at the extraction position, and all the remaining support units 4 are located at the storage position. At the extraction position, the container 200 can be exchanged. At the storage position, the liquid contained in the container 200 can be supplied to the liquid discharge apparatus 1. In this embodiment, at the extraction position, the support unit 4 is separated from the storage portion 23A. However, the extraction position may be a position where the end portion of the support unit 4 is held in the storage portion 23A, and can be any position where the container 200 can be exchanged with respect to the support unit 4.

The support portion 40 includes a placement surface 41 on which the container 200 is placed, and the four sides of the placement surface 41 are defined by left and right side plates 44, a front end portion 42, and a rear end portion 43. A notch portion 44a is formed in each side plate 44. A concave portion 43a on which the connecting portion 201 is arranged is formed at the rear end portion 43.

At the front end portion 42, a handle 45 that is rotatable about a shaft 45a extending in the X direction is provided, and the user can rotate the handle 45 in a direction d1. The handle 45 also serves as an operation handle of an engaging portion 48. The handle 45 is provided with the engaging portion 48, and an engaging portion 39 that engages with the engaging portion 48 is formed on the bottom portion of a case 30 that forms the storage portion 23A. In this embodiment, the engaging portion 48 is a projecting portion, and the engaging portion 39 is a concave portion in which the engaging portion 48 is inserted. When the engaging portion 48 and the engaging portion 39 engage with each other, the support unit 4 can be prevented from dropping from the storage portion 23A even if a vibration acts on it due to, for example, movement of the liquid supply apparatus 20. The handle 45 is always biased, by an elastic member 421, to the side of the engaging position (the position in a state ST051 shown in FIG. 6) where the engaging portion 48 engages with the engaging portion 39. The elastic member 421 is, for example, a coil spring. When the user grasps the handle 45 and rotates it in a direction indicated by the arrow in a state ST052 in FIG. 6, the engaging portion 48 and the engaging portion 39 are disengaged, and the support unit 4 inserted into the storage portion 23A can be extracted from the storage portion 23A.

To prevent the container 200 stored in the storage portion 23A from being carelessly extracted, the regulating mechanism 46 that regulates extraction of the container 200 from the storage portion 23A is provided for each storage portion 23A. The regulating mechanism 46 according to this embodiment is a lock mechanism that locks the support unit 4 to the storage position.

The regulating mechanism 46 includes a slide member 461 incorporated in the front end portion 42. To allows the user to operate the slide member 461, an operation portion 461a that is a part of the slide member 461 is exposed from the front end portion 42. The slide member 461 is provided to be movable in the direction of an arrow d2 (X direction) between a lock position where the rotation of the handle 45 in the direction d1 is regulated and an unlock position where the rotation of the handle 45 is permitted.

The state ST051 in FIG. 6 and a state ST061 in FIG. 7 indicate a state in which the slide member 461 is located at the lock position. That is, the regulating mechanism 46 is in a regulating state in which extraction of the container 200 is regulated. The slide member 461 includes an abutment portion 461b, and the abutment portion 461b abuts against an abutment portion 451 provided on the handle 45 like a rib. In the state ST051 in FIG. 6 and the state ST061 in FIG. 7, the slide member 461 is an obstacle, and the handle 45 cannot be rotated in the disengaging direction. Hence, the support unit 4 cannot be extracted from the storage portion 23A.

A state ST062 in FIG. 7 indicates a state in which the slide member 461 is located at the unlock position. That is, the regulating mechanism 46 is in a regulation cancel state in which extraction of the container 200 is permitted. The notch portion of the abutment portion 461b and the abutment portion 451 are at positions facing each other. At this time, since the abutment portion 451 can escape to the notch portion of the abutment portion 461b, as indicated by a state ST063 in FIG. 7, the handle 45 can be rotated to the disengaging direction as indicated by the state ST052 in FIG. 6. In this way, when the user slides the slide member 461 to the unlock position and then operates the handle 45, the support unit 4 can be extracted from the storage portion 23A.

The storage portion 23A is provided with a sensor 38 that detects the state of the regulating mechanism 46. The sensor 38 according to this embodiment detects the position of the slide member 461. The sensor 38 is, for example, an optical sensor (for example, a photointerrupter) capable of detecting a detection piece 461c of the slide member 461. If the slide member 461 is located at the lock position, the detection piece 461c is located at the detection position of the sensor 38, as shown in FIG. 5, and detected by the sensor 38. If the slide member 461 is located at the unlock position, the detection piece 461c is not located at the detection position of the sensor 38 and is not detected by the sensor 38. It is therefore possible to determine, based on the detection result of the sensor 38, whether the position of the slide member 461 is the lock position or the unlock position, that is, whether the state of the regulating mechanism 46 is the regulating state or the regulation cancel state.

Opening/closing of the passage valve 52 can be interlocked with the detection result of the sensor 38. For example, if the sensor 38 detects that the position of the slide member 461 is the unlock position in a case where the passage valve 52 is in the open state, the passage valve 52 is immediately closed interlockingly with the detection. This can prevent the support unit 4 from being removed from the storage portion 23A in a state in which the passage valve 52 is open. If the support unit 4 is removed from the storage portion 23A in a state in which the passage valve 52 is open, air may enter from the path forming member 5 into the tube 51. This causes a problem such as sticking of the liquid in the tube 51 or discharge failure in the discharge head 1008. If it is detected that the position of the slide member 461 is the unlock position, the passage valve 52 is immediately closed by automatic control interlockingly with the detection, thereby preventing air from entering the tube 51.

### Tilt of Slot

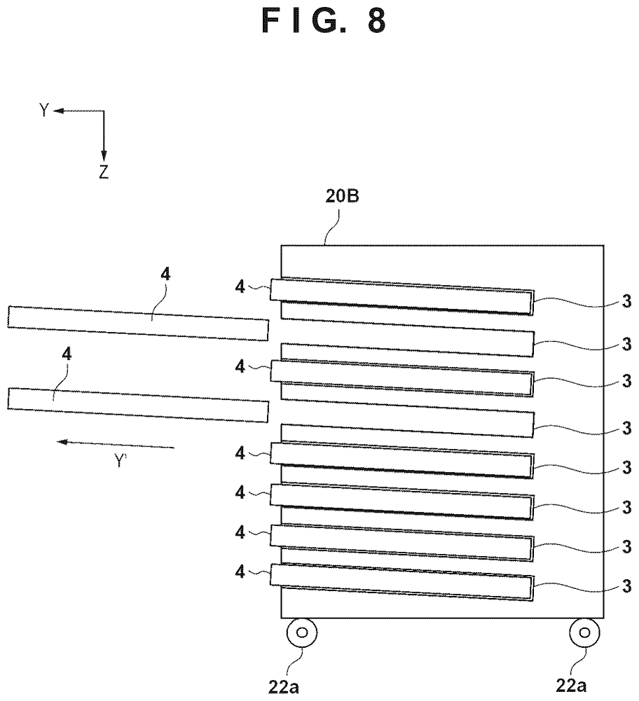

FIG. 8 is a view showing the attachment posture and the insertion/removal mode of the support unit 4 to the storage portion 23A. As shown in FIG. 8, the storage portion 23A of each stage provided in the liquid supply apparatus 20B is tilted and lowered to the lower (+Z) side toward the rear side (far side or −Y side). Note that this also applies to the storage portions 23A of the liquid supply apparatus 20A.

In the attached state, the support unit 4 is held in a tilting posture, and in the container 200, the end portion 200a is located on the lower side of the end portion 200b in the gravity direction (Z direction). The tilt angle is, for example, smaller than 45° with respect to the horizontal plane and particularly 10° or less. In the example shown in FIG. 8, the tilt angle is assumed to be 3°.

### Liquid Stirring Mechanism

The stirring mechanism provided in the liquid supply apparatus 20B will be described. Various kinds of liquids can be contained in the container 200 and used for image printing, maintenance of the discharge head 1008, or the like. For example, an aqueous ink, a latex ink, or a solvent-based ink such as eco-solvent can be contained in the container 200. Depending on the type of ink, a color material (a pigment component or the like) in the ink may be sedimented along with the elapse of time. The particle size of a color material or the type and amount of an additive may change between ink colors, and the sedimentation speed may change depending on the ink color. Also, a reaction liquid that is discharged from the discharge head 1008 and reacts with ink to fix the ink on the surface of the print medium M can also be contained in the container 200. For the container 200 containing a liquid having such a property that the components are separated, the contained liquid is appropriately stirred, thereby improving evenness. This contributes to, for example, preventing lowering of quality of a printed image.

In this embodiment, for the container 200 stored in the storage portion 23A, a stirring unit 6 performs a stirring operation of stirring the liquid contained in the container 200. The stirring unit 6 according to this embodiment physically presses the container portion 202 of the container 200 from the outside, thereby changing its posture (deforming it). The contained liquid is thus flowed in the container portion 202 and stirred.

Depending on the liquid contained in the container 200, it need not be stirred. In this embodiment, the storage portions 23A having a stirring function and the storage portions 23A without the stirring function are provided. More specifically, the storage portions 23A at the upper stages of the liquid supply apparatus 20B do not have the stirring function, and the storage portions 23A at the middle to lower stages have the stirring function. All storage portions 23A may have the stirring function, as a matter of course. Also, the storage portions 23A of the liquid supply apparatus 20A may have a similar stirring function.

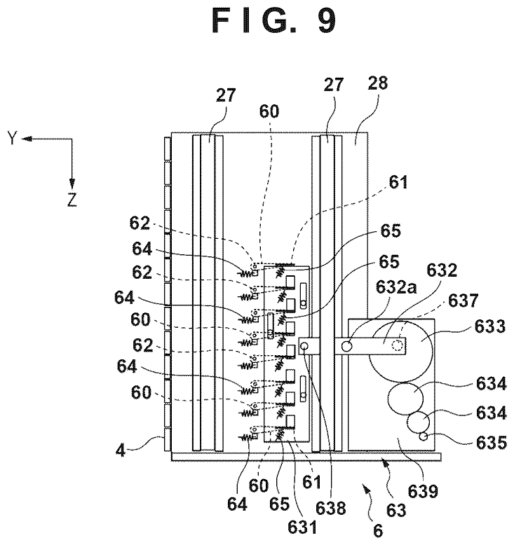

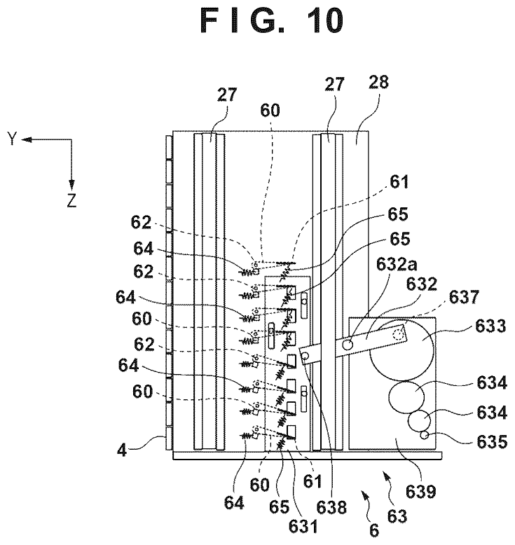

The configuration of the stirring unit 6 will be described with reference to FIGS. 4, 9, and 10. FIGS. 9 and 10 are operation explanatory views of the stirring unit 6 when the main body 22 of the liquid supply apparatus 20B is viewed from sideward. The stirring unit 6 includes a plurality of pressing members 60, and a moving mechanism 63 common to the plurality of pressing members 60. The pressing member 60 is provided for each storage portion 23A. The pressing member 60 is arranged at a position facing the support unit 4 attached to the storage portion 23A and the container 200 supported by the support unit 4. When the moving mechanism 63 synchronously rotates each pressing member 60 about a rotation shaft 62, a pressing portion 61 provided on the pressing member 60 presses the container 200 from above and relaxes the pressing. FIG. 9 shows a state in which the pressing portion 61 (and the pressing member 60) are located at a pressing relaxing position, and FIG. 10 shows a state in which the pressing portion 61 (and the pressing member 60) are located at a pressing position.

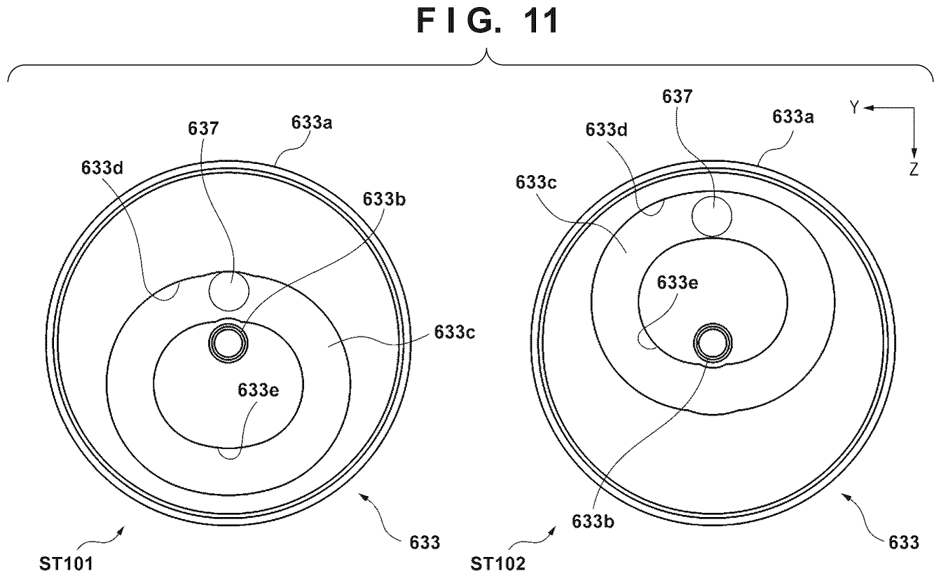

The configuration of the moving mechanism 63 will be described. The output of a motor 635 that is the driving source of the moving mechanism 63 is transmitted to a cam 633 via a plurality of gears 634. Note the rotation shaft of each component is in the X direction. The configuration of the cam 633 will be described here with reference to FIG. 11. FIG. 11 is an explanatory view of the cam 633, and a state ST102 shown in FIG. 11 indicates a state in which the cam 633 has rotated by 180° from a state ST101 in FIG. 11.

The cam 633 is a disc-shaped member that can rotate about a shaft 633b in the X direction, and a gear tooth portion 633a is formed on the outer peripheral surface. The gear tooth portion 633a meshes with the gear 634, and the cam 633 rotates when the gear 634 rotates. A groove 633c is formed in the side surface of the cam 633, and the outer and inner side surfaces of the groove 633c form an outer cam surface 633d and an inner cam surface 633e, respectively. In the groove 633c, a cam follower 637 connected to a driving transmission lever 632 is arranged. The inner cam surface 633e is located on the inner side of the cam follower 637 in the radial direction of the cam 633, and when the cam 633 rotates, the inner cam surface 633e comes into contact with the cam follower 637 and acts to move the cam follower 637 upward. Also, the outer cam surface 633d is located on the outer side of the cam follower 637 in the radial direction of the cam 633, and when the cam 633 rotates, the outer cam surface 633d comes into contact with the cam follower 637 and acts to move the cam follower 637 downward.

FIGS. 4, 9, and 10 will be referred to again. When the cam follower 637 moves up/down in accordance with the rotation of the cam 633, the driving transmission lever 632 rotates about a rotation shaft 632a. Since the driving transmission lever 632 is rotatably connected to a shaft portion 638 provided on an elevating member 631, the operation of the driving transmission lever 632 is converted into the elevating operation of the elevating member 631. When the cam 633 rotates by one revolution, the cam follower 637 performs a reciprocating operation once in the Z direction, and therefore, the elevating member 631 similarly performs a reciprocating elevating operation once via the driving transmission lever 632.

The elevating member 631 having a plate shape is attached to a side plate 28 of the main body 22 such that it can move up/down in the Z direction. In addition, two, front and rear columns 27 each having a U-shaped section and extending in the Z direction are fixed on the side plate 28. The columns 27 are attached to the side plate on the −X side as well, and the main body 22 ensures its strength as a structure by the total of four columns 27. The weight of a number of containers 200 can thus be supported.

The column 27 has a high strength and a thickness. Hence, if the moving mechanism 63 is provided outside in the X direction with respect to the columns 27 attached to the side plate 28, the size in the X direction becomes large. Hence, in this embodiment, the elevating member 631 and the driving mechanism such as the cam 633 are distributed to the front and rear sides of one the column 27 in the Y direction. The driving transmission lever 632 is inserted into a through hole 27a formed in the one column 27.

This makes it possible to suppress an increase of the size of the main body 22 in the X direction and arrange the moving mechanism 63 of the stirring unit 6 while ensuring the strength. Furthermore, the driving transmission lever 632 is attached to a plate-shaped support member 639 that supports the moving mechanism 63. By detaching fixing elements such as fastening screws, most components of the moving mechanism 63 can be detached to the rear surface side of the main body 22 as an integrated unit together with the support member 639. Hence, parts exchange by a service man can easily be performed. Note that fastening and unfastening of the fixing elements such as fastening screws can easily be done by fastening these from the rear surface side of the main body 22.

Biasing forces of two springs 64 and 65 act on each pressing member 60. The spring 64 has one end attached to the pressing member 60 and the other end attached to the storage portion 23A (case 30). Also, the spring 65 has one end attached to the pressing member 60 and the other end attached to the elevating member 631. The pressing member 60 is a movable member (particularly a rotating member) that is attached to the storage portion 23A (case 30) such that it can rotate about the rotation shaft 62 as the rotation center. The rotation shaft 62 is a shaft in a direction crossing the moving direction (Z direction) of the pressing portion 61. Both the two springs 64 and 65 bias the pressing member 60 in a direction to rotate it clockwise in FIGS. 9 and 10.

When the pressing member 60 is at the pressing relaxing position (FIG. 9), the elevating member 631 contacts the pressing member 60 and raises itself. Hence, the biasing force of the spring 65 acts between the elevating member 631 and the pressing member 60. For this reason, the biasing force of the spring 65 acts only between the elevating member 631 and the pressing member 60 and does not serve as a load for the motor 635. That is, the load applied to the moving mechanism 63 at the pressing relaxing position includes only the biasing force of the spring 64 and the weights of the components.

Also, when the pressing member 60 is at the pressing position (FIG. 10), the cam 633 has a phase 180° oppose to that at the pressing relaxing position, and the pressing portion 61 of the pressing member 60 contacts the container 200 and presses it downward. The pressing distance of the pressing portion 61, that is, the rotation amount of the pressing member 60 changes depending on the remaining amount in the container 200. In FIG. 9, the pressing members 60 at the four upper stages indicate a mode in which the containers 200 that are full of liquid are pressed. The pressing members 60 at the four lower stages indicate a mode in which the containers 200 that are deflated because of very little remaining amount are pressed. The biasing forces of both the springs 64 and 65 and the weights of the components act on the container 200. Since the springs 64 and 65 are arranged in each storage portion 23A, even if the remaining amounts in the containers 200 of the storage portions 23A are different, an optimum pressing force can be applied to each container 200.

At this time, the biasing force of the spring 64 acts on the container 200 but not on the elevating member 631. The biasing force of the spring 65 acts between the container 200 and the elevating member 631 which are in contact via the pressing member 60. The cam 633 acts to move the elevating member 631 downward to the lower side of the container 200. Thus, using the two springs 64 and 65 at different attachment positions and the cam 633 capable of moving both upward and downward, the load applied to the moving mechanism 63 at the time of operation is reduced.

Note that at the pressing position, since the extensions of the springs 64 and 65 are smaller when the container 200 is deflated because of a small remaining amount, the pressing force acting on the container 200 is also small. If the remaining amount in the container 200 is large, the reaction force from the container 200 is readily received at the time of pressing, and a larger pressing force is needed to deeply push in. Conversely, if the remaining amount is small, the reaction force from the container 200 is small. For this reason, even if the pressing force is small, it is possible to deform the container 200 and easily move the liquid inside. In other words, the push-in amount (pressing amount) of the pressing member 60 to push in the container 200 changes in accordance with the remaining amount of the liquid in the container 200. For this reason, the springs 64 and 65 are arranged at positions where the pressing force decreases along with the deflation of the container 200. Hence, the biasing forces of the springs need not be more than necessity. In this embodiment, the load applied to the pressing portion 61 is adjusted to, for example, about 500 gf when the container 200 is full of liquid or about 300 gf when the remaining amount is little.

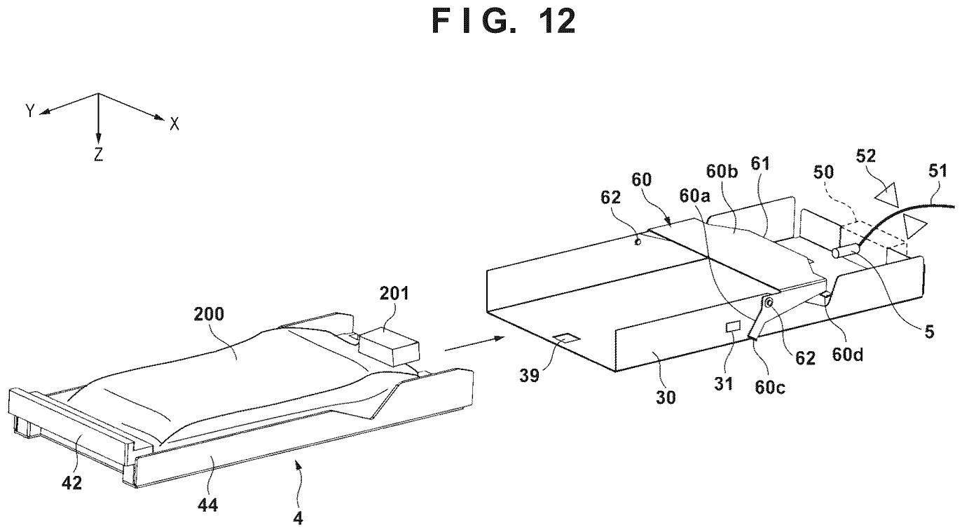

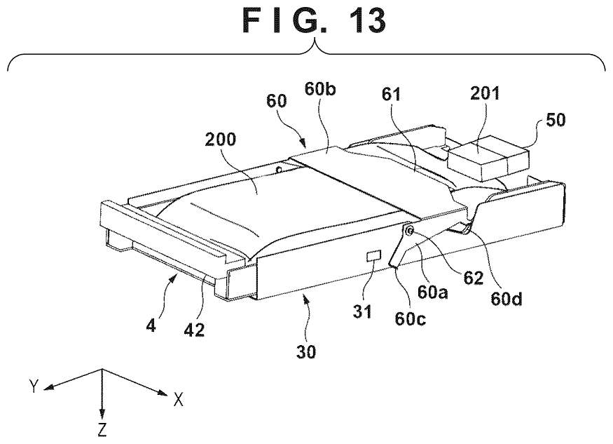

The configuration of the pressing member 60 will be described with reference to FIGS. 12 and 13. FIG. 12 is a perspective view of the case with a stirring function and the support unit in a separated state. FIG. 13 is a perspective view of the case with a stirring function and the support unit in an attached state.

The pressing member 60 includes a pair of side plates 60a located on the side portions of the case 30 in the X direction, and a top plate 60b straddling the case 30 in the X direction and connected between the pair of side plates 60a. On each side plate 60a, the pressing member 60 is rotatably supported by the case 30 via the rotation shaft 62, and the pressing portion 61 is formed at the distal end of the top plate 60b.

A lock portion 60c on which an end portion of the spring 64 is locked, and an abutment portion 60d on which an end portion of the spring 65 is locked and which abuts against the elevating member 631 at the time of rising of the elevating member 631 and causes rotation of the pressing member 60 are formed on each side plate 60a. Both the lock portion 60c and the abutment portion 60d are formed in a form of a projecting piece projecting in the X direction.

A remaining amount detection sensor 31 is provided on a side portion of the case 30. The remaining amount detection sensor 31 is, for example, an optical sensor. The remaining amount detection sensor 31 is a position detection sensor that detects the side plate 60a and thus detects the position of the pressing portion 61, and is also a sensor that detects the remaining amount in the container 200 based on the position detection result. More specifically, as for the detection position of the remaining amount detection sensor 31, it is arranged at a position to detect the side plate 60a when the container 200 deflated because of the decrease of the remaining amount is pressed. This uses the fact that the push-in amount at the time of pressing changes depending on the degree of deflation of the container 200. In this embodiment, since the pressing portion 61 is brought into contact with the container 200, the position of the side plate 60a reflects the remaining amount in the container 200, and therefore, the accuracy of remaining amount detection is high. The detection position of the remaining amount detection sensor 31 is designed such that, for example, the side plate 60a is detected when the container 200 whose remaining amount is about 100 ml is pressed.

The pressing member 60 can be formed by, for example, a plate material made of a metal (steel plate, or the like). As compared to a member of a resin or the like, since the strength is high even if it is thin, the height of the storage portion 23A can be suppressed. The rotation shaft 62 of the pressing member 60 is arranged on the outer side of the container 200 in the X direction, and is provided at a position where the rotation shaft 62 and the container 200 overlap in the X direction when the container 200 is full of liquid. With these contrivances to suppress the size in the Z direction, even if the pressing member 60 is installed in the storage portion 23A of each stage to impart the stirring function, the containers 200 of multiple stages can be stored in a limited space under the housing of the system A.

Also, the width of the pressing member 60 in the X direction is smaller at the pressing portion 61 than near the rotation shaft 62. Thus, if the pressing portion 61 presses a tank, it is possible to prevent portions other than the pressing portion 61 from contacting the container 200 and prevent the container 200 from being damaged.

When the width of the pressing member 60 in the X direction is made smaller at the pressing portion 61 than near the rotation shaft 62, the following advantage can be obtained. As described above, the gusset portions 202a are provided on the side surfaces of the container 200. The gusset portion 202a includes a welded portion between flexible members, and has higher rigidity than the other portions. To deflate the container 200 by folding the gusset portions 202a inside in accordance with a decrease of the remaining amount, an adequate pressing force is needed. In a state in which the remaining amount in the container 200 is large, the gusset portions 202a are expanded in the up/down direction, and the gusset portions 202a are sometimes expanded not inside but outside. To squeeze the gusset portions 202a, an adequate pressing force is needed.

When the pressing portion 61 is arranged inside the gusset portions 202a in the X direction, it is possible to efficiently press and deform the container 200 for stirring. That is, the pressing portion 61 is arranged to press the center side of the container 200 with respect to the gusset portions 202a. The height of the gusset portions 202a is, for example, about 20 mm on both side surfaces. When the pressing portion 61 is located inside the gusset portions 202a on both side surfaces, it hardly receives the reaction force of the gusset portions 202a and can efficiently press the container 200. The pressing efficiency can further be improved by designing the width of the pressing portion 61 in the X direction such that it is fitted, for example, 10 mm or more inside from the gusset portions 202a. This is because when the pressing portion 61 is apart from the gusset portions 202a in the X direction, the influence of the reaction force of the gusset portions 202a is smaller. Note that the width of the pressing portion 61 in the X direction is preferably designed apart from the gusset portions 202a by at least 1 mm, and may be designed apart by, for example, 5 mm or 10 mm.

As a form for minimizing the width of the pressing portion 61 in the X direction, for example, the pressing portion 61 may be in point contact with the container 200. However, in a case where the container 200 is long in the Y direction, as in this embodiment, if the pressing portion 61 is in point contact with the container 200, the fluidity of the liquid in the container 200 may lower. More specifically, if the width of the pressing portion 61 in the X direction is too small, the flow of the liquid corresponding to the push-in amount of the pressed container 200 is dispersed even outside in the X direction, the flow amount of the liquid in the Y direction decreases.

Hence, for example, if the width of the pressing portion 61 in the X direction is set to ⅓ or more the width of the container portion 202 of the container 200 in the X direction, the fluidity of the liquid in the Y direction can be improved in the container portion 202 at the time of pressing. For example, if the width of the container portion 202 in the X direction is 180 mm, the width of the pressing portion 61 in the X direction is set to 60 mm or more, thereby improving the fluidity of the liquid in the Y direction in the container portion 202 at the time of pressing.

To summarize, if the width of the container portion 202 in the X direction is 180 mm, and the height of the gusset portions 202a is 20 mm, the width of the pressing portion 61 in the X direction is preferably 60 mm to 120 mm and may be particularly 90 mm.

### Stirring Operation

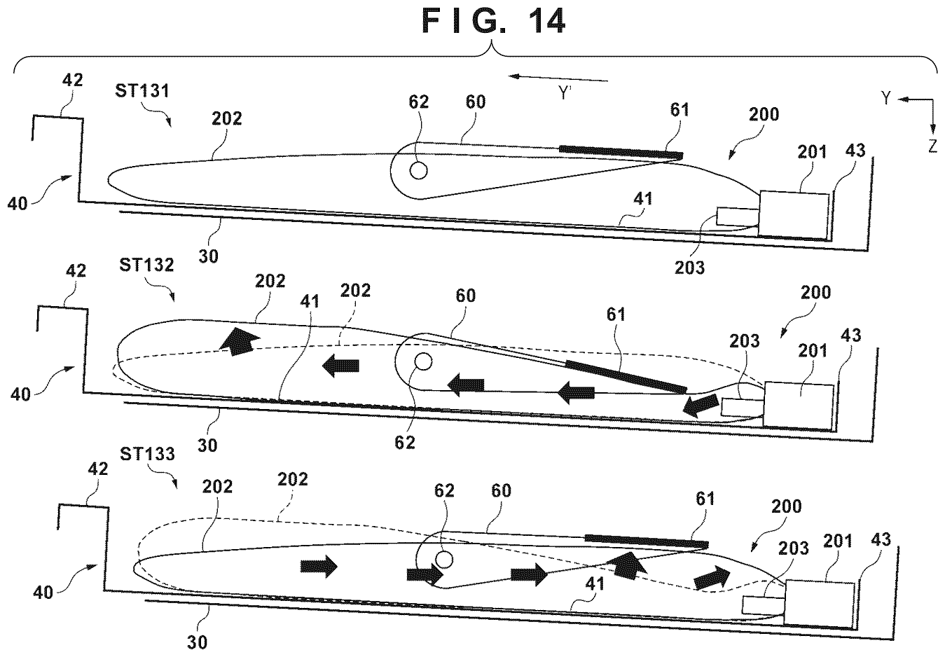

The stirring operation of the liquid in the container 200 by pressing the pressing portion 61 against the container 200 will be described with reference to FIG. 14. FIG. 14 is an explanatory view of the stirring operation. As shown in FIG. 8, the attachment posture of the support unit 4 is tilted in this embodiment. In FIG. 14, a direction parallel to the tilt angle direction of the attachment posture is defined as a Y′ direction. In the following explanation, the side of the connecting portion 201 of the container 200 will sometimes be referred to as a −Y′ direction, and the opposite side will sometimes be referred to as a +Y′ direction. Note that arrows in FIG. 14 indicate the direction of liquid flow that occurs in the container portion 202 of the container 200.

In this embodiment, the stirring operation includes a pressing operation and a pressing relaxing operation. The pressing portion 61 is arranged facing the placement surface 41 of the support unit 4. The pressing portion 61 is reciprocally moved between the pressing relaxing operation and the pressing operation. The posture of the container portion 202 is thus changed to cause the flow of the liquid inside and stir it.

A state ST131 in FIG. 14 indicates a state in which the pressing portion 61 (and the pressing member 60) is at the pressing relaxing position. In this embodiment, at the pressing relaxing position, the pressing portion 61 is apart from the placement surface 41 and is located at a height not to contact the container portion 202, and does not press the container portion 202. Hence, it can also be said that the pressing relaxing position is a pressing cancel position.

The moving mechanism 63 is driven from the state ST131 in FIG. 14, and the pressing operation is performed, as indicated by a state ST132 in FIG. 14. In the pressing operation, the pressing member 60 rotates, and the pressing portion 61 moves to a position where it is closer to the placement surface 41 than at the pressing relaxing position and presses the container portion 202 to the side of the placement surface 41. Thus, the posture of the container portion 202 changes such that it is partially recessed, and the liquid inside is flowed to the side of the end portion 200b and stirred.

In this embodiment, the container 200 is attached in a tilting posture to the storage portion 23A while directing the connecting portion 201 to the lower side in the Z direction. Hence, at the stage of the state ST131 in FIG. 14, the liquid in the container 200 is readily distributed while being localized on the side of the connecting portion 201 by the weight of its own, and the container portion 202 expands more on the side of the connecting portion 201 than at the central portion in the Y′ direction. The pressing portion 61 is designed to press the side of the end portion 43 provided with the connecting portion 201 out of the end portions 42 and 43 of the container 200. Since the pressing portion 61 presses the expanded portion of the container portion 202 or a portion close to it, the flow of the liquid in the container portion 202 can be promoted. The portion that the pressing portion 61 presses may be the most expanded portion of the container portion 202.

Note that if the tilt angle is too large, the localization of the liquid in the container 200 is large, and the reaction force by the weight of the gathered liquid increases. As a result, when pressing by the pressing member 60, the load applied to the pressing member 60 increases. For this reason, as described above, the tilt angle is preferably set to less than 45° and particularly preferably 10° or less. The tilt angle in this embodiment is set to 3°. The tilt angle may be set in accordance with the liquid amount that can be contained in the container 200. For example, if the liquid amount is small, the tilt angle may be set larger than in a case where the liquid amount is large.

Since the pressing portion 61 presses the container portion 202 on the side of the connecting portion 201, stirring can effectively be performed when the liquid flows to the opposite side. The rotation shaft 62 of the pressing member 60 is located on the opposite side of the connecting portion 201 in the Y′ direction of the container 200 when viewed from the pressing portion 61. In the pressing operation, the rotation direction of the pressing member 60 is the clockwise direction in the state ST132 shown in FIG. 14. That is, the pressing member 60 rotates clockwise about the rotation shaft 62 as the rotation center. When the rotation direction is thus set, a vector in the +Y′ direction is generated, and the liquid can readily be flowed in the +Y′ direction. That is, the liquid readily flows, in the container portion 202, to the end portion on the side opposite to the side of the connecting portion 201.

As described above, in this embodiment, the pressing portion 61 is designed to press the side of the end portion 43 provided with the connecting portion 201 out of the end portions 42 and 43 of the container 200. A portion of the container portion 202 near the intake port 203 of the container 200 is pressed, and stirring of the liquid around there is particularly promoted. In printing, the liquid in the container 200 flows out from a region close to the intake port 203 to the tube 51. By pressing the portion near the intake port 203 and stirring the liquid, the liquid whose concentration is more even can be sent to the tube 51.

The moving mechanism 63 is driven from the state ST132 in FIG. 14, and the pressing relaxing operation is performed, as indicated by a state ST133 in FIG. 14. In the pressing relaxing operation, the pressing member 60 rotates, and the pressing portion 61 returns from the pressing position to the pressing relaxing position. The pressing member 60 rotates counterclockwise about the rotation shaft 62 as the rotation center in the state ST133 in FIG. 14. That is, when transiting from the state ST132 in FIG. 14 to the state ST133 in FIG. 14, the pressing member 60 reverses the rotation direction. When pressing by the pressing member 60 is relaxed, the container portion 202 is going to restore its original shape while the liquid in the container portion 202 flows. That is, the pressing relaxing operation is an operation of returning the posture of the container portion 202 changed by the pressing operation to the original posture. The posture need not be completely the same as the original position, as a matter of course. After that, the pressing operation can be performed again.

The pressing operation and the pressing relaxing operation are repetitively performed, thereby stirring the liquid in the container portion 202. That is, when the pressing portion 61 is at the pressing position, as indicated by the state ST132 in FIG. 14, the portion of the container 200 near the pressing portion 61 is recessed, the liquid flows in the +Y′ direction, and a portion of the container 200 on the opposite side of the connecting portion 201 is expanded. After that, when pressing is relaxed, as in the state ST133 shown in FIG. 14, the ink flowed by the pressing flows in the −Y′ direction by the weight of its own. By repeating the pressing operation and the pressing relaxing operation, the liquid is reciprocally moved in the Y′ direction in the container portion 202 and stirred. The flow of the liquid caused by the pressing relaxing operation uses the weight of the liquid. When the weight of the liquid is used, the mechanism necessary for stirring the liquid can have a simple configuration.

Note that during the series of pressing operations shown in FIG. 14, the passage valve 52 can be either in the open state or the closed state. That is, control is performed such that the passage valve 52 is in the open state in a path where supply of the liquid to the discharge head 1008 is performed, and the passage valve 52 is in the closed state in a path where supply of the liquid to the discharge head 1008 is not performed. Hence, during the series of pressing operations shown in FIG. 14, a printing operation by the discharge head 1008 can be performed concurrently.

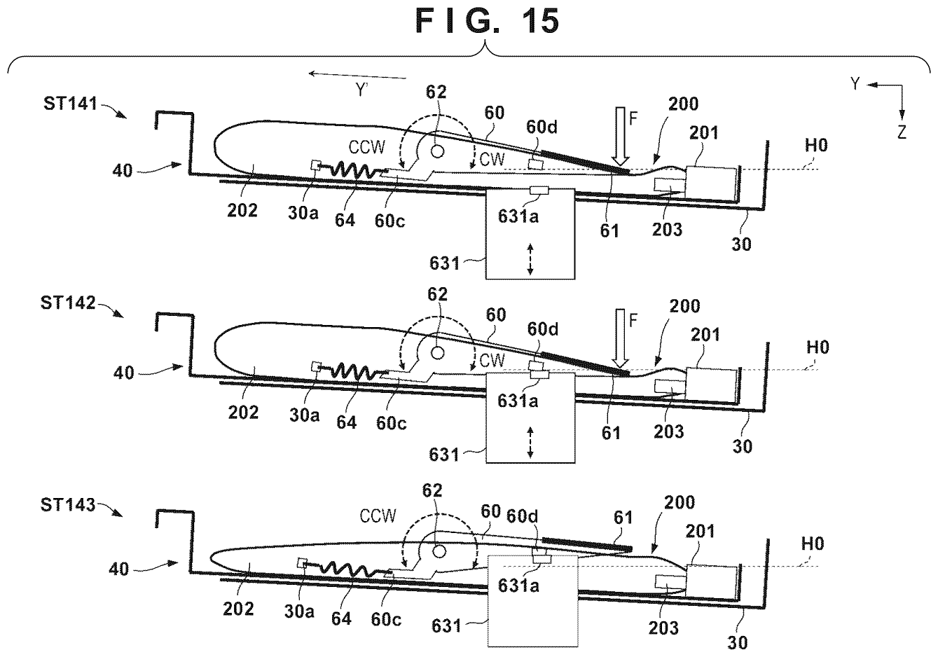

The operations of the pressing member 60 and the moving mechanism 63 in the series of pressing operations shown in FIG. 14 will be described with reference to FIG. 15. The pressing member 60 rotates about the rotation shaft 62, and the pressing portion 61 is set in the pressing state by rotation in the CW direction and set in the pressing relaxing state by rotation in the CCW direction.

The action of the spring 64 will be described. The lock portion 60c is formed on the pressing member 60, and a lock portion 30a is formed on the case 30. The spring 64 is provided between the lock portions 60c and 30a. By the tensile force of the spring 64, the pressing member 60 is biased to rotate in the CW direction, and the pressing portion 61 is set in the pressing state.

The elevating member 631 is provided with an abutment portion 631a. As indicated by a state ST142 in FIG. 15, when the elevating member 631 moves upward, the abutment portion 631a of the elevating member 631 abuts against the abutment portion 60d of the pressing member 60. This position is defined as an abutment reference height H0. As indicated by a state ST143 in FIG. 15, when the elevating member 631 further moves upward, the pressing member 60 rotates about the rotation shaft 62 in the CCW direction, and the pressing portion 61 is set in the pressing relaxing state.

Conversely, when the elevating member 631 moves downward, the abutment portion 631a of the elevating member 631 is separated from the abutment portion 60d of the pressing member 60. By the tensile force of the spring 64, the pressing member 60 is biased to rotate in the CW direction, and the pressing portion 61 is set in the pressing state again. In this way, the pressing member 60 rotates between the pressing position and the pressing relaxing position by the elevating motion of the elevating member 631.

In a state ST141 shown in FIG. 15, rotation of the pressing member 60 stops at a position where a pressing load F of the pressing portion 61 by the spring 64 balances the reaction force of the container 200. For this reason, if the remaining amount of the liquid in the container 200 decreases, the position (pressing position) where the forces balance lowers accordingly. Since the pressing height of the pressing member 60 changes depending on the remaining amount of the liquid in the container 200, it is possible to press the container 200 and stir the liquid, following the remaining amount of the liquid in the container 200.

Next, when repeating the stirring operation, liquid stirring performance can be adjusted by the frequency or the period. In the pressing relaxing operation, the liquid in the container portion 202 flows a little later after the rotation of the pressing member 60. In the pressing relaxing operation, the higher the fluidity of the liquid is, the higher the stirring effect is. Also, if the pressing operation is performed after the liquid sufficiently flows, the liquid containing amount of the container portion 202 becomes large near the pressing portion 61, and the container portion 202 expands. Hence, by pressing there, the stirring performance can further be improved. The frequency of the stirring operation is, for example, a frequency slower than several Hz and, particularly, a frequency slower than 1 Hz. If the frequency of the stirring operation is too slow, the total time of the stirring operation increases, and the power consumption of the motor 635 may increase. Hence, the frequency of the stirring operation may be set in the range of, for example, 0.5 to 0.7 Hz and, particularly, to 0.6 Hz.

In addition, when the remaining amount decreases, and the container 200 is deflated, the ink on the upper side (+Y′ side) of the tilting container 200 flows by the weight of its own to the −Y′ side, and the containing amount in this portion decreases. To the contrary, the liquid stays on the lower side (−Y′ side). In this state, the flow distance of the liquid in the +Y′ direction at the time of the pressing operation is short, and the time of return of the liquid in the pressing relaxing operation is also short. Hence, the period of the stirring operation may be shortened in accordance with the decrease of the remaining amount in the container 200.

In the stirring operation, the pressing operation and the pressing relaxing operation may be repeated while providing a time interval between the pressing relaxing operation and the next pressing operation. It is possible to ensure a long flow time of the liquid in the container portion 202 from the pressing relaxing operation to the start of the next pressing operation and further promote the flow of the liquid by the weight of its own. For example, when the operation is stopped for 0.1 to 0.5 sec in the state ST132 shown in FIG. 14 and the state ST133 shown in FIG. 14, it is possible to promote the flow of the liquid and improve the stirring efficiency. The time of stop is appropriately set in accordance with the liquid amount that can be contained in the container portion 202.

There are several methods for adjusting the period of the stirring operation. First, there is a method using a dwell angle that is a range where the cam follower 637 in contact with the inner cam surface 633e or the outer cam surface 633d is not displaced even if the cam 633 rotates. For example, the dwell angle at a position where the cam follower 637 is at the highest point is set to 40°, and the dwell angle at the lowest point is also set to 40°. In particular, when a dwell angle of 40° is ensured at the highest point, the pressing relaxing position can be maintained.

Also, an index angle that is an angle range for raising or lowering the cam follower 637 may largely be set to 140°. As effects, this decreases the load at the time of rotation of the cam 633, and the connected pressing member 60 is slowly transitioned from the pressing state to the pressing relaxing position, thereby ensuring time to move ink to the vicinity of the pressing portion 61. These make it possible to sufficiently move the ink at the time of pressing cancel and enhance the stirring effect.

As another method, the motor 635 is temporarily stopped at the pressing relaxing position. If time corresponding to the dwell angle of 40° is implemented by motor stop, the dwell angle can be made smaller. Hence, the index angle can be made larger, and the load at the time of cam rotation can further be reduced.

As for the timing to execute the stirring operation, it can be executed at any timing during the operation of supplying the liquid to the liquid discharge apparatus 1, during the recovery operation of the discharge head 1008 in the liquid discharge apparatus 1, during standby of the printing operation, and the like. The stirring period to repetitively perform the stirring operation may be set based on time or based on the operation count. For example, several ten minutes may be defined as one set, and the stirring operation may repetitively be performed only one set a day. Alternatively, for example, several ten times may be defined as one set, and the stirring operation may repetitively be performed only one set a day. The necessary stirring period or execution timing may be set in consideration of the sedimentation speed of the color material in the liquid.

Referring to FIG. 8, the container 200 and the support unit 4 are attached to the storage portion 23A, and these are tilted with respect to the horizontal plane, as described above. From the viewpoint of the liquid stirring effect, it is advantageous that the tilt angle is smaller than 45°, and it is more advantageous that the tilt angle is, for example, smaller than 20°, particularly, 10° or less. In the example shown in FIG. 8, the tilt angle is assumed to be 3°.

Stirring by pressing is possible even if the tilt angle is close to 90°, but the weight of the ink acts in the direction of resisting the flow of the liquid by pressing. Hence, a larger pressing force is needed to make the liquid sufficiently flow. If the tilt angle is less than 45°, the vector of the flow of the liquid toward the −Y direction is relatively small because of the weight of the liquid. As for the expansion amount of the portion of the container portion 202 on the −Y side at the time of pressing operation, if the tilt angle is 10 or less, a large expansion amount can be obtained by a smaller pressing force. If the expansion amount of the container portion 202 at the time of pressing is large, the flow amount of the liquid inside is large. That is, the efficiency of pressing is high.

Note that in this embodiment, at the pressing relaxing position, the pressing portion 61 is located at a height not to contact the bag container portion 202. However, the pressing portion 61 may contact the container portion 202, and the pressing portion 61 may be located at a position to press the container portion 202 with a pressing amount smaller than that at the pressing position. In such a slightly pushed-in state at the pressing relaxing position, the upper limit position of the pressing member 60 in the Z direction can be suppressed low, and the size of the liquid discharge apparatus 1 in the Z direction can be reduced.

Also, in this embodiment, the pressing member 60 is provided in the case 30 of the storage portion 23A. However, the pressing member 60 may be provided on the support unit 4. In this case, a configuration that enables driving transmission between the moving mechanism 63 and the pressing member 60 when the support unit 4 is attached to the storage portion 23A is added.

Additionally, in this embodiment, a configuration in which the container 200 is pressed by the pressing portion 61 has been described. For example, the container 200 may be deformed by repeating pressing and stop of compressed air. Also, the container 200 may be deformed by pressurizing and depressurizing the space around the container 200.

### Indicator Device

An indicator device provided in the liquid supply apparatus 20B will be described with reference to FIG. 4. On the main body 22, a state indicator 33 and a type indicator 34 are provided for each storage portion 23A. The state indicator 33 and the type indicator 34 are arranged on the front wall portion 22b to be adjacent to the opening of the corresponding storage portion 23A. Note that although not illustrated, the liquid supply apparatus 20A also includes the state indicator 33 and type indicator 34, which are the same as described above, for each storage portion 23A.

In this embodiment, the state indicator 33 is an electronic indicator and makes a notification concerning the state of the container 200 attached to the corresponding storage portion 23A. More specifically, the state indicator 33 is formed by a plurality of light emitting elements, and it is possible to notify the user of the state of the corresponding container 200 by combining drive modes (for example, light-on and blinking, light-on and light-off, blinking and light-off, or the like).

The state of the container 200 to be notified to the user is, for example, the remaining amount of the liquid in the container 200. The consumed amount (discharge amount) of the liquid contained in the container 200 can be estimated from the discharge control amount of the discharge head 1008. The remaining amount of the liquid in the container 200 is estimated based on the estimated consumed amount, and if the remaining amount is less than a threshold, one of two light emitting elements 21a and 21b is made to blink. Thus, the user can be notified of the exchange time of the container 200 and promoted to prepare the container 200 that is full of liquid.

The type indicator 34 indicates information concerning the type of the liquid assigned to the corresponding storage portion 23A. The type indicator 34 may be an electronic indicator. In this embodiment, however, it is a nonelectronic indicator and is a plate material or sheet (color label) made of paper or plastic with the color of the liquid. By the type indicator 34, the user can visually understand to which storage portion 23A the container 200 containing what kind of liquid should be attached.

### Box-Shaped Storage Portion

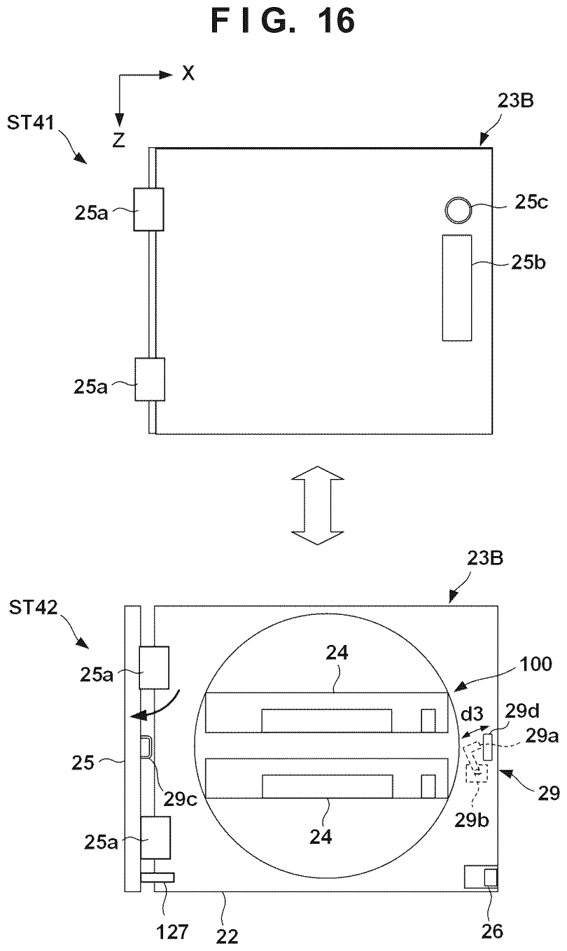

The configuration of the storage portion 23B will be described. FIG. 16 is a front view of the storage portion 23B. A state ST41 indicates a state in which the opening/closing member 25 is closed, and a state ST42 indicates a state in which the opening/closing member 25 is open.

The opening/closing member 25 is a door whose one end portion in the X direction is supported by the front wall portion 22b via a plurality of hinges 25a, and a handle 25b that the user can grasp is provided at the other end portion in the X direction. If the user pulls the handle 25b to the near side from the state ST41, the opening/closing member 25 rotates about the hinges 25a serving as a rotation center, and the inside of the storage portion 23B is exposed, as shown in the state ST42. Note that in this embodiment, the opening/closing member 25 is of a rotation type but may be of a sliding type.

A stirring unit 100 is incorporated in the storage portion 23B. A plurality of support units 24 that support the containers 200 are detachably inserted into the stirring unit 100 in the Y direction. In this embodiment, two support units 24 can be attached to the stirring unit 100. The stirring unit 100 has a function of stirring the liquid in the containers 200 supported by the support units 24. Details of the stirring unit 100 will be described later.

A sensor 26 that detects the open/closed state of the opening/closing member 25 is provided on the main body 22. The sensor 26 detects a detection piece 27 provided on the opening/closing member 25. The sensor 26 is, for example, an optical sensor and is arranged to detect the detection piece 27 in the closed state of the opening/closing member 25 and not to detect the detection piece 27 in the open state of the opening/closing member 25.

To prevent the container 200 stored in the storage portion 23B from being carelessly extracted, a regulating mechanism 29 that regulates extraction of the container 200 from the storage portion 23B is provided. The regulating mechanism 29 according to this embodiment is a lock mechanism that locks the opening/closing member 25 to the main body 22.

The regulating mechanism 29 includes a latch claw 29a provided on the main body 22, and an electric actuator 29b that rotates the latch claw 29a. The actuator 29b is, for example, a rotary solenoid. The actuator 29b rotates the latch claw 29a in the direction of an arrow d3 between a lock position at which an end portion of the latch claw 29a enters an opening portion 29d provided in the main body 22 and an unlock position at which the end portion of the latch claw 29a retreats from the opening portion 29d. FIG. 16 shows a state in which the latch claw 29a is located at the unlock position.

The opening/closing member 25 is provided with a U-shaped striker 29c that enters the opening portion 29d in the closed state. In the closed state of the opening/closing member 25, if the latch claw 29a rotates to the lock position, the striker 29c and the latch claw 29a engage with each other, and the opening/closing member 25 cannot be opened. That is, the regulating mechanism 29 is in a regulating state in which extraction of the container 200 is regulated. In the closed state of the opening/closing member 25, if the latch claw 29a rotates to the unlock position, the engagement between the striker 29c and the latch claw 29a is canceled, and the opening/closing member 25 can be opened. That is, the regulating mechanism 29 is in a regulation cancel state in which extraction of the container 200 is permitted.

An operation button 25c that the user can operate is provided on the opening/closing member 25. The operation button 25c is a push button type switch. If the operation button 25c is operated in a state in which the closed state of the opening/closing member 25 is detected by the sensor 26, the actuator 29b is controlled such that the latch claw 29a rotates between the lock position and the unlock position for each operation.

### Support Unit

FIG. 17 is a perspective view of the liquid container 200 and the support unit 24. The support unit 24 basically has the same configuration as the support unit 4. The support unit 24 includes a support portion 240 that supports the container 200, and has a form of a tray, as a whole, on which the container 200 in a lying posture is placed. The support portion 240 includes a placement surface 241 on which the container 200 is placed, and the four sides of the placement surface 241 are defined by left and right side plates 244, a front end portion 242, and a rear end portion 243. A notch portion 244a is formed in each side plate 244. A concave portion 243a on which the connecting portion (outlet member) 201 is arranged is formed at the rear end portion 243. A rib 244b extending in the Y direction is provided on each side plate 244.

### Liquid Stirring Mechanism

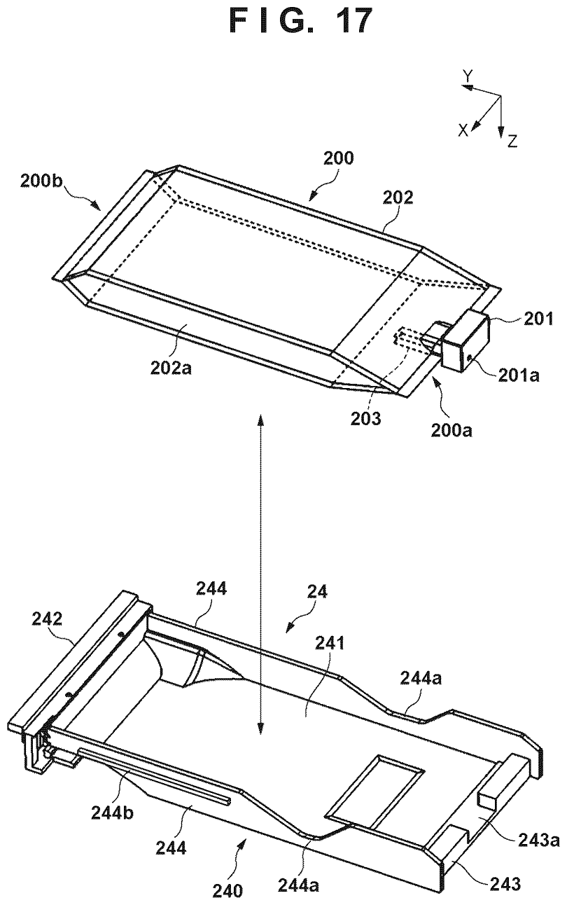

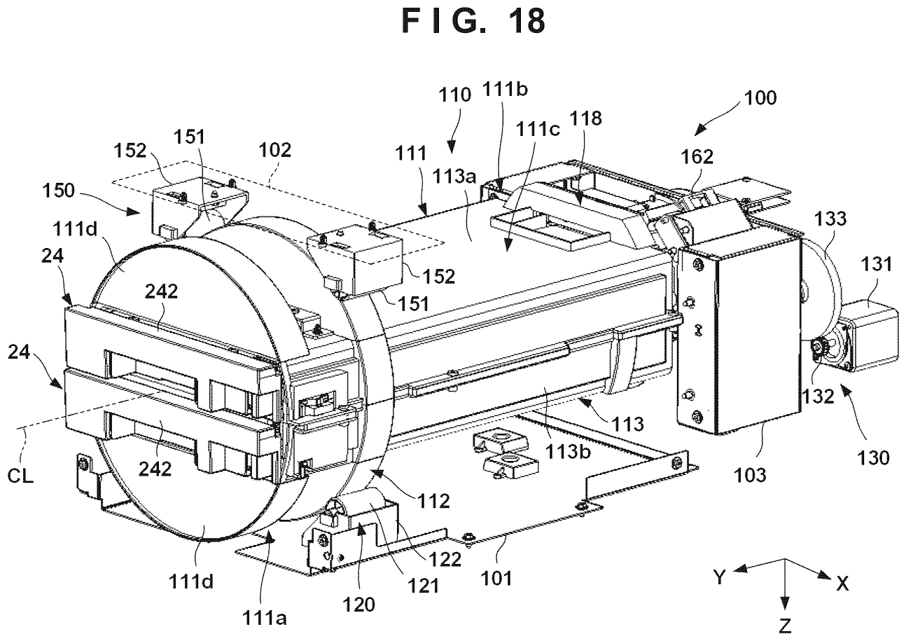

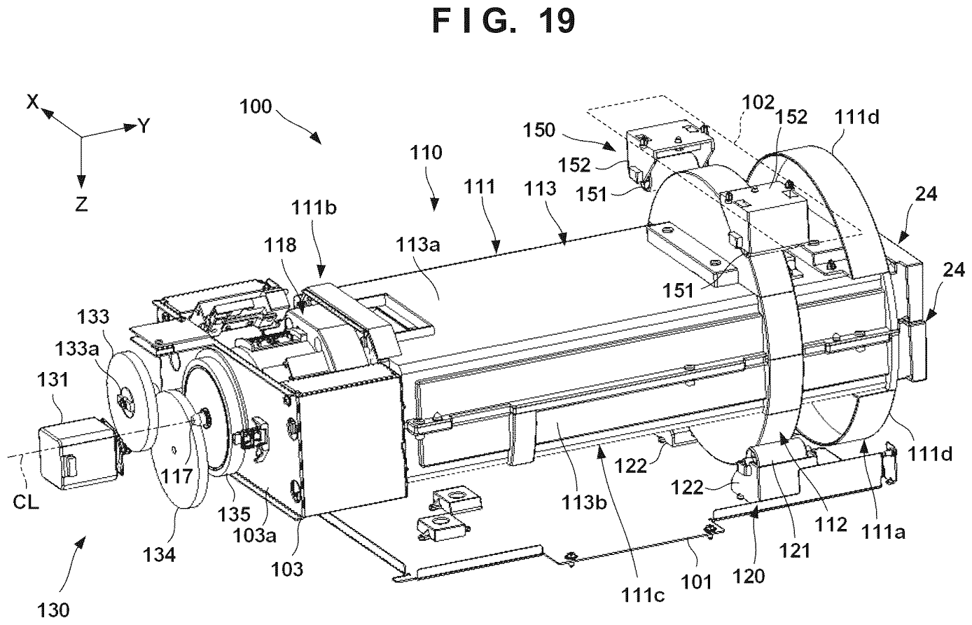

FIGS. 18 and 19 are perspective views of the stirring unit 100. FIG. 18 is a perspective view of the stirring unit 100 viewed from the front side, and FIG. 19 is a perspective view of the stirring unit 100 viewed from the rear side.

The stirring unit 100 includes a container unit 110 that stores a liquid, a support unit 120 that rotatably supports the container unit 110, and a driving unit 130 that rotates the container unit 110 supported by the support unit 120. These components are supported by the main body 22 of the liquid supply apparatus 20A via frames including frames 101 to 103.

In this embodiment, the container unit 110 is rotated about a rotational centerline CL indicated as a virtual line, thereby stirring the liquid contained in the container unit 110. When the container unit 110 is rotated, the liquid can be stirred more effectively. The rotational centerline CL is a line passing through the container unit 110, and the direction is the Y direction in this embodiment.

In this embodiment, two support units 24 are formed such that these can freely be inserted/removed to/from the container unit 110 from the front side of the container unit 110. Thus, liquids in the two containers 200 can simultaneously be stirred. The two support units 24 are attached to the container unit 110 while overlapping as two, upper and lower stages. Note that the number of attachable support units 24 may be three or more or may be one.

The driving unit 130 is arranged on the rear side of the container unit 110, and a relatively wide space is ensured on the front side of the container unit 110. This improves the insertion/removal properties of the support unit 24 for the user with respect to the container unit 110. Also, since the stirring unit 100 has a structure extending in the Y direction as a whole, the stirring unit 100 can be made compact in the X direction.

FIGS. 18 and 19 will be referred to. The container unit 110 includes a container member 111 and a shaft fixing member 118, which are connected in the direction of the rotational centerline CL.

The container member 111 is a hollow member that contains the container 200. The container member 111 includes, in the direction of the rotational centerline CL (Y direction), a front end portion 111a that is one end portion, and a rear end portion 111b that is the other end portion. Between the front end portion 111a and the rear end portion 111b, an outer wall portion 111c of the container member 111 is formed by a cylindrical tube-shaped portion 112 and a polygonal tube-shaped portion 113. The cylindrical tube-shaped portion 112 is formed on the side of the front end portion 111a with respect to the rear end portion 111b, and the polygonal tube-shaped portion 113 is formed on the side of the front end portion 111a and the side of the rear end portion 111b from the cylindrical tube-shaped portion 112. The cylindrical tube-shaped portion 112 forms a cylindrical outer peripheral surface. The polygonal tube-shaped portion 113 substantially has a rectangular tube shape. In front view of the stirring unit 100, fan-shaped cover members 111d that cover the components on the rear side of the front end portion 111a are attached to the front end portion 111a.

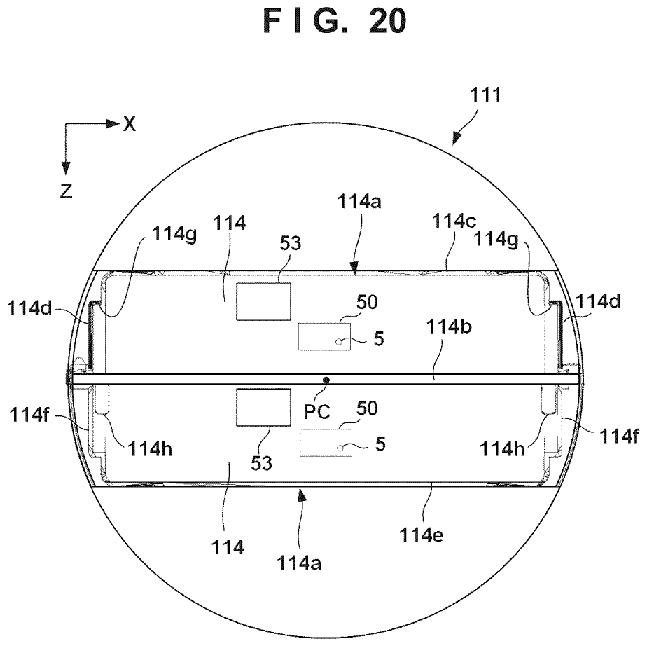

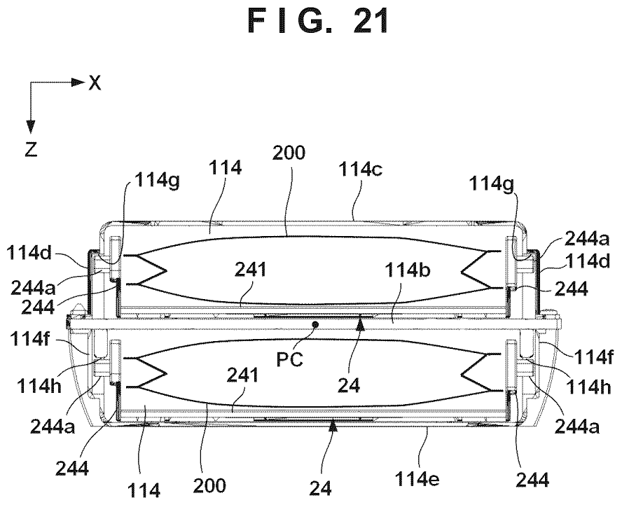

FIGS. 20 and 21 will be referred to, in addition to FIGS. 18 and 19. FIG. 20 is a front view of upper and lower container spaces 114 formed by the container member 111, and shows a state in which the support units 24 are detached from the container spaces 114. FIG. 21 is a front view of the upper and lower container spaces 114, and particularly shows a form (sectional shape) in which the support units 24 are contained in the container spaces 114. The container spaces 114 are formed throughout the cylindrical tube-shaped portion 112 and the polygonal tube-shaped portion 113. Note that matters concerning directions in the following explanation assume a case where the container unit 110 is located at the initial position, unless it is specifically stated otherwise.

The internal space of the container member 111 is divided into two, upper and lower stages by a partition wall 114b extending in the X and Y directions, and the container spaces 114 along the rotational centerline CL are formed on the upper and lower sides of the partition wall 114b. At the front end portion 111a of the container member 111, opening portions 114a serving as an exit and entrance of the container spaces 114 open.

The support unit 24 can displace in the Y direction between a containing position where the container 200 is contained in the container space 114 and an extraction position where the container 200 is exposed to the outside of the container unit 110. At the extraction position, the container 200 can be exchanged. Since the container 200 can be exchanged, a liquid replenishing work can quickly be performed, and the support unit 24 can repetitively be used. Also, in this embodiment, since structures that obstruct the exchange work rarely exist near the opening portion 114a, the exchange workability of the container 200 is high.

Note that in this embodiment, at the extraction position, the support unit 24 is apart from the container space 114. However, the extraction position may be a position where the end portion of the support unit 24 is held inside the container space 114, and can be any position where the container 200 can be exchanged with respect to the support unit 24.

On the far side of the container space 114 (the side of the end portion 111b of the container member 111), the connecting unit 50 or the reader/writer 53 described with reference to FIG. 5 is provided.

The container space 114 according to this embodiment is a flat space having a cuboid shape, which extends in the Y direction and whose height in the Z direction is shorter than the width in the X direction. Note that the container space 114 may be a flat space having a cuboid shape, which extends in the Y direction and whose height in the Z direction is longer than the width in the X direction.

The container space 114 on the upper side is defined by a top wall 114c, left and right side walls 114d, and the partition wall 114b serving as a bottom wall, and the container space 114 on the lower side is defined by a bottom wall 114e, left and right side walls 114f, and the partition wall 114b serving as a top wall. The partition wall 114b serving as the bottom wall of the container space 114 on the upper side and the bottom wall 114e of the container space 114 on the lower side can be provided with engaging portions corresponding to an engaging portion 234 that holds the support unit 24 described with reference to FIG. 7 at the containing position.

A guide portion 114g is formed on each of the left and right side walls 114d of the container space 114 on the upper side. The guide portion 114g has a sectional shape having a shoulder shape with a step or tilt, and extends in the Y direction. At the time of insertion/removal of the support unit 24 to/from the container space 114, the guide portion 114g functions as a rail that comes into slidable contact with the rib 244b of the support unit 24, and guides the displacement of the support unit 24 in the insertion/removal direction. In addition, the guide portion 114g abuts against the rib 244b in a direction (the Z direction at the initial position) crossing the direction of the rotational centerline CL, thereby regulating displacement of the support unit 24 in the crossing direction. This can suppress looseness of the support unit 24 in the container space 114 at the time of rotation of the container unit 110.

Similarly, a guide portion 114h is formed on each of the left and right side walls 114f of the container space 114 on the lower side. The guide portion 114h has a convex shape projecting downward from the partition wall 114b, and extends in the Y direction. At the time of insertion/removal of the support unit 24 to/from the container space 114, the guide portion 114h functions as a rail that comes into slidable contact with the rib 244b of the support unit 24, and guides the displacement of the support unit 24 in the insertion/removal direction. In addition, the guide portion 114h abuts against the rib 244b in a direction (the Z direction at the initial position) crossing the direction of the rotational centerline CL, thereby regulating displacement of the support unit 24 in the crossing direction. This can suppress looseness of the support unit 24 in the container space 114 at the time of rotation of the container unit 110.

A rotation center PC of the container unit 110 is located on the partition wall 114b. The rotation center PC is an arbitrary point on the rotational centerline CL. According to the configuration of this embodiment, since the rotational centerline CL passes between the two container spaces 114, the liquids in the two containers 200 can be stirred more evenly by the container unit 110.

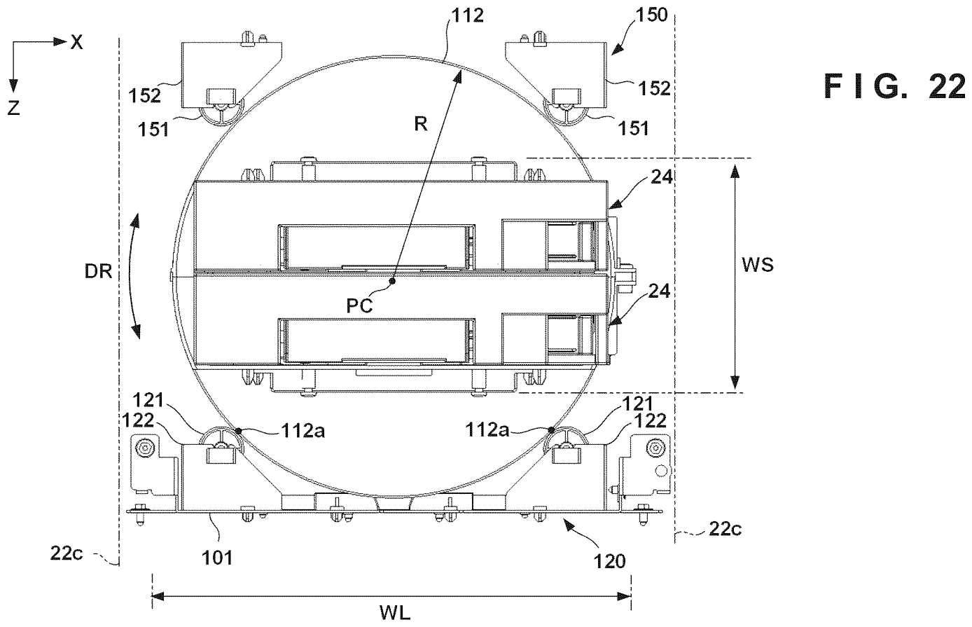

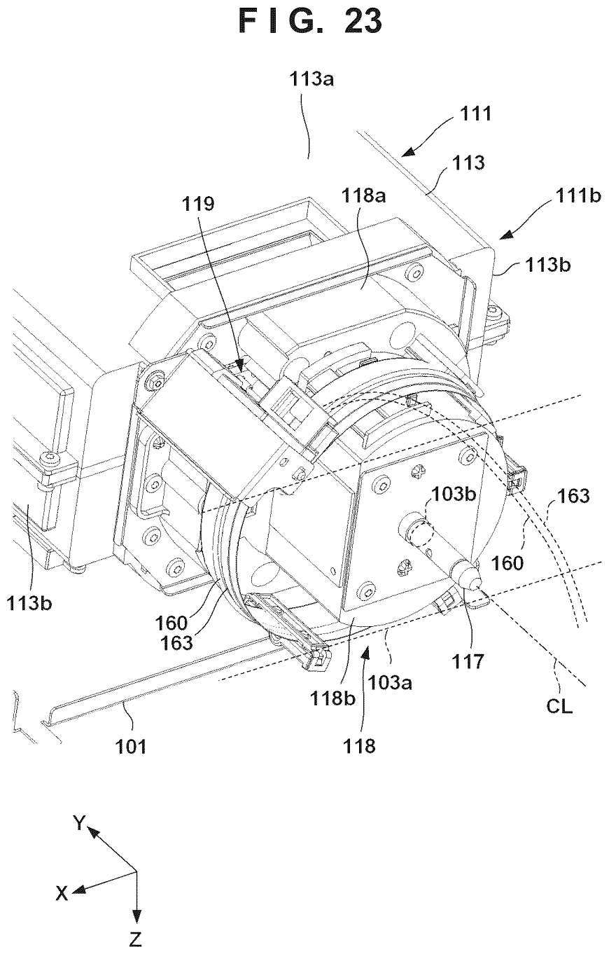

A structure that rotatably supports the container unit 110 will be described with reference to FIGS. 18, 19, 22, and 23. FIG. 22 is a front view of the stirring unit 100 and mainly shows the rotation support structure of the container unit 110. FIG. 23 is a perspective view showing the rear portion of the container unit 110 in a state in which the driving unit 130 is detached.

If the container unit 110 includes a shaft between two end portions on the rotational centerline CL, the existence of the shaft and bearings may lower the degree of freedom of design or lower the convenience for the user. For example, in a structure in which the support unit 24 is inserted/removed into/from the container unit 110, as in this embodiment, the insertion/removal point or the insertion/removal direction may be restricted. Also, in a structure in which a large capacity of liquid is stored and stirred, the rigidity of the shaft and the bearings need to be increased in consideration of the weight of the liquid.

In this embodiment, the problem is solved by combining the support unit 120 that is a shaftless support structure, and a support structure with shaft (a shaft member 117 and a bearing member 103a to be described later).

The support unit 120 is a mechanism that rotatably supports the container unit 110 by abutting against the outer wall portion 111c of the container unit 110. In the support unit 120 according to this embodiment, a plurality of abutment portions 121 abut against the cylindrical tube-shaped portion 112 of the container member 111, thereby rotatably supporting the container unit 110 about the rotational centerline CL. In this embodiment, the support unit 120 includes two abutment portions 121, and the two abutment portions 121 abut against the cylindrical tube-shaped portion 112 at abutment positions 112a apart in the circumferential direction of the cylindrical tube-shaped portion 112.

Each abutment portion 121 according to this embodiment is a roller that is supported by a bearing 122 about an axis in a direction (Y direction) parallel to the rotational centerline CL. The bearing 122 is supported by the frame 101. The peripheral surface of the abutment portion (roller) 121 abuts against the cylindrical tube-shaped portion 112, and the container unit 110 can roll in the direction of an arrow DR in FIG. 12 in the spot in a state in which it is placed between the two abutment portions (rollers) 121. Since the container unit 110 is supported from below by the two abutment portions 121, even if the container unit 110 stores a large capacity of liquid, and the weight of the liquid is large, structural stability can be obtained without needing to greatly increase the rigidity.

The cylindrical tube-shaped portion 112 is formed on the side of the front end portion 111a with respect to the rear end portion 111b of the container member 111, and the support unit 120 rotatably supports the container unit 110 at a position on the side of the front end portion 111a with respect to the rear end portion 111b. The container unit 110 is supported by the shaftless support unit 120 near the opening portions 114a serving as an exit and entrance to insert/remove the support units 24 into/from the container spaces 114. Since there is neither a shaft nor a bearing in the front portion of the stirring unit 100, the convenience of the insertion/removal work of the support unit 24 by the user can be improved. Also, in the insertion/removal work of the support unit 24, a load in the gravity direction readily acts near the opening portions 114a in some cases. However, since the two abutment portions 121 support the container unit 110 from below near the opening portions 114a, it is possible to stably receive the load.

In addition, since the container member 111 has a structure including the cylindrical tube-shaped portion 112 and the polygonal tube-shaped portion 113, it is possible to reduce the weight and decrease the moment of inertia of rotation as compared to a case where the whole structure is formed by the cylindrical tube-shaped portion 112. The polygonal tube-shaped portion 113 includes long side portions 113a and short side portions 113b, which form the outline of the rectangle. In this embodiment, a width WL of the long side portion 113a, a width WS of the short side portion 113b, and a radius R of the cylindrical tube-shaped portion 112 hold relationships given by WL>WS, and WS<2×R. Since the width WS of the polygonal tube-shaped portion 113 is smaller than the diameter (2×R) of the cylindrical tube-shaped portion 112, it is possible to reduce the weight and decrease the moment of inertia of rotation.

On the other hand, a relationship given by WL>2×R holds, and the cylindrical tube-shaped portion 112 and the abutment positions 112a are located inside a virtual circle VC that passes through the outermost portion of the container unit 110 and has the rotation center PC as the center. Hence, the stirring unit 100 can be made compact. A side wall 22c of the storage portion 23B can be made closer to the container unit 110, and the stirring unit 100 can be made compact in the X direction.

The shaft member 117 is provided in the rear portion of the container unit 110 (the side of the rear end portion 111b). The shaft member 117 is fixed at an end portion of the shaft fixing member 118 and extended on the rotational centerline CL. The shaft fixing member 118 is a hollow body including a flange portion 118a fixed to the rear end portion 111b of the container member 111, and a trunk portion 118b extending backward from the flange portion 118a, and the shaft member 117 is fixed to the end portion of the trunk portion 118b. The frame 103 includes a plate-shaped bearing member 103a, and the shaft member 117 is inserted to a shaft hole 103b and supported. Since not only the support unit 120 but also the shaft member 117 and the bearing member 103a rotatably support the container unit 110, a shift of the rotation center PC of the container unit 110 can be prevented, and more stable rotation can be implemented. Since the shaft member 117 and the bearing member 103a are located on the opposite side of the container unit 110 with respect to the opening portions 114a, the convenience of the insertion/removal work of the container support unit 24 by the user is not deteriorated.

The stirring unit 100 also includes a regulating unit 150 that regulates the displacement of the container member 111 in a direction crossing the rotational centerline CL. The regulating unit 150 according to this embodiment regulates the displacement of the container member 111 upward in the Z direction. When inserting/removing the support unit 24, if a force in an upward direction acts on the front side of the container unit 110, and the posture tilts, a load in a bending direction acts on the shaft member 117. When the regulating unit 150 is provided, such a posture change can be prevented.

The regulating unit 150 according to this embodiment includes a plurality of abutment portions 151 that face the cylindrical tube-shaped portion 112 in the Z direction at positions on the upper side of the rotational centerline CL. If the container member 111 is going to displace upward, the plurality of abutment portions 151 abut against the cylindrical tube-shaped portion 112 and physically stop the displacement. The plurality of abutment portions 151 may always abut against the cylindrical tube-shaped portion 112, or may be located at positions slightly apart in the Z direction in a normal state.

In this embodiment, the regulating unit 150 includes two abutment portions 151, and the two abutment portions 151 are arranged apart in the circumferential direction of the cylindrical tube-shaped portion 112. Each abutment portion 151 according to this embodiment is a roller that is supported by a bearing 152 about an axis in a direction (Y direction) parallel to the rotational centerline CL. The bearing 152 is supported by the frame 102.

The X- and Y-direction positions of the two abutment portions 151 are the same as those of the two abutment portions 121 of the support unit 120. Same components can be used for the two sets of the abutment portions 151 and the bearings 152 and the two abutment portions 121 and the bearings 122 of the support unit 120. Component types can be reduced by sharing the components.

The structure of the driving unit 130 will be described with reference to FIGS. 18 and 19. The driving unit 130 is arranged on the outer side (rear side) of the rear end portion 111b of the container member 111 in the direction of the rotational centerline CL. Since the driving unit 130 is arranged on the opposite side of the container unit 110 with respect to the opening portions 114a, mechanisms existing around the opening portions 114a can be decreased, and the convenience of the insertion/removal work of the support unit 24 by the user can be improved.

The driving unit 130 includes a motor 131 as a driving source. The motor 131 is fixed to a frame (not shown). A gear 132 is attached to the output shaft of the motor 131. In this embodiment, the motor 131 is a stepping motor. The rotation amount of the container unit 110 can be controlled by the rotation amount of the motor 131. The motor 131 may be a DC motor, and in this case, a rotation amount sensor such as a rotary encoder may be provided to control the rotation amount.

The driving unit 130 includes gears 133, 134, and 135. The gears 133 and 134 are rotatably supported by a frame (not shown). Each of the gears 133 and 134 is a two-stage gear, the gear 132 and the large gear of the gear 133 mesh with each other, and the large gear of the gear 134 meshes with the small gear of the gear 133. In addition, the gear 135 meshes with the small gear of the gear 134. Between the small gear and the large gear of the gear 133, a torque limiter 133a capable of blocking driving transmission between these is provided. By the torque limiter 133a, it is possible to prevent an overload from acting on the motor 131. Also, if the user erroneously touches the container unit 110 during rotation of the container unit 110, the torque limiter 133a blocks transmission of the driving force, and it is therefore possible to prevent a high load from acting on the user's hand.

The gear 135 is fixed to the shaft member 117. When the motor 131 is driven, the driving force is transmitted to the shaft member 117, and the container unit 110 rotates. The bearing member 103a is located between the gear 135 and the shaft fixing member 118, and the container unit 110 is positioned by these in the direction of the rotational centerline CL. Note that in this embodiment, a gear mechanism is used as the mechanism for transmitting the driving force from the motor 131 to the shaft member 117, but a transmission mechanism of another type such as a belt transmission mechanism may be used.

A structure configured to discharge the liquid from the container 200 via the path forming member 5 will be described with reference to FIGS. 19 and 23. Between the rear end portion 111b of the container member 111 and the shaft fixing member 118, a discharge unit 119 is provided at the rear end portion 111b. In the discharge unit 119, a passage valve corresponding to the passage valve 52 in FIG. 5 is provided for each container space 114 and communicates with the corresponding path forming member 5.

In this embodiment, it is assumed that the containers 200 containing a liquid of the same type are stored in the two container members 111. For this reason, the passage valves communicate with a common tube 160, and the liquid is supplied to the liquid discharge apparatus 1 via the tube 160. In a partial section, the tube 160 is routed together with an electric cable (for example, a flexible flat cable) 163. The electric cable 163 includes, for example, the electric wires of the motor and the sensor.

### Stirring Operation

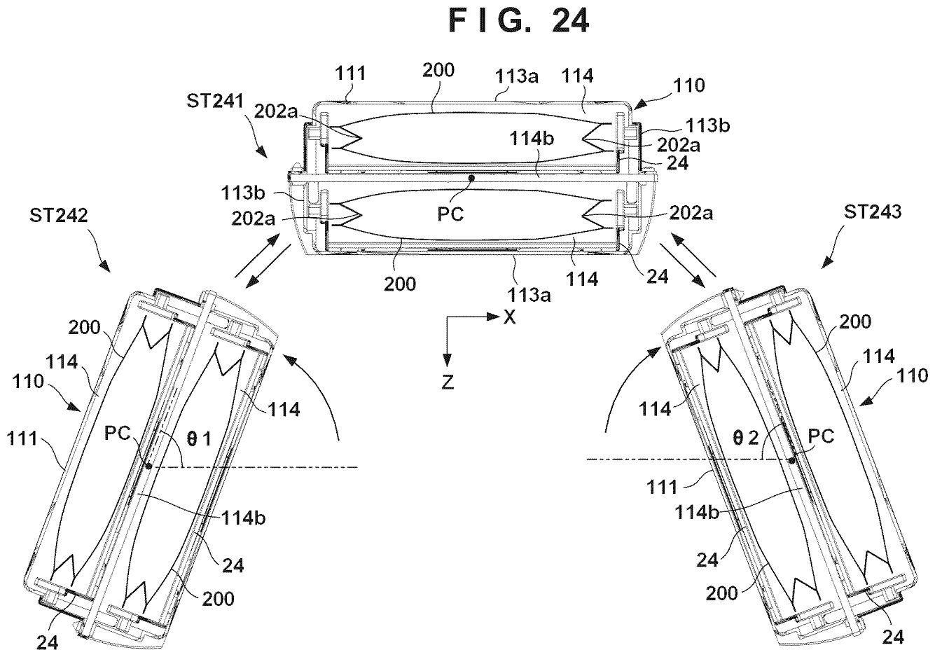

FIG. 24 shows an example of a stirring operation (the rotation operation of the container unit 110) by driving of the driving unit 130. A state ST241 indicates a state in which the container unit 110 is located at the initial position. At the initial position, the container member 111 is in a horizontal posture with the long side portions 113a being horizontal. The support portion 240 of the support unit 24 and the container 200 in each container space 114 are also in the horizontal posture, and the gusset portions 202a on both side surfaces of the container 200 are located at the same height.

A state ST242 indicates a tilting state in which the container unit 110 rotates counterclockwise from the initial position by an angle θ1. The position of the container unit 110 in this state is called a left tilting position. As for the gusset portions 202a on both side surfaces of the container 200, the gusset portion 202a on the right side in FIG. 24 is located at a position higher than that of the gusset portion 202a on the left side. The liquid in the container 200 flows from the side of the gusset portion 202a on the right side to the side of the gusset portion 202a on the left side.

A state ST243 indicates a tilting state in which the container unit 110 rotates clockwise from the initial position by an angle θ2. The position of the container unit 110 in this state is called a right tilting position. As for the gusset portions 202a on both side surfaces of the container 200, the gusset portion 202a on the left side in FIG. 24 is located at a position higher than that of the gusset portion 202a on the right side. The liquid in the container 200 flows from the side of the gusset portion 202a on the right side to the side of the gusset portion 202a on the left side.

When the posture of the container unit 110 is repetitively changed as, for example, state ST241→state ST242→state ST241→state ST243→state ST241→ . . . , the liquid in the container 200 can be stirred.

When changing the posture of the container unit 110 from the state ST242 to the state ST243, rotation may be temporarily stopped in the state ST241 halfway. Conversely, the posture of the container unit 110 may continuously be changed from the state ST241 to the state ST243 without stopping rotation in the state ST241 halfway. This also applies to a case where the posture of the container unit 110 is changed from the state ST243 to the state ST242.

Alternatively, between the state ST242 and the state ST243, without stopping rotation in the state ST241 halfway, the posture of the container unit 110 may continuously be changed a plurality of times, and after that, rotation may be stopped for a predetermined time in the state ST241. This operation may repetitively be performed. While power consumption of the motor 131 is reduced by stopping rotation for a predetermined time in the state ST241, the rotation is resumed before sedimentation of the particles in the liquid progresses, thereby maintaining the evenness of the liquid.

The angle θ1 and the angle θ2 may be the same angle or may be different angles. The angle θ1 and the angle θ2 may be the same angle if the stirring operation is performed under a certain condition, and may be different angles if the stirring operation is performed under another condition. If the angle θ1 and the angle θ2 are different angles, the magnitude relationship may alternately be switched between θ1>θ2 and θ1<θ2.

### Control Circuit

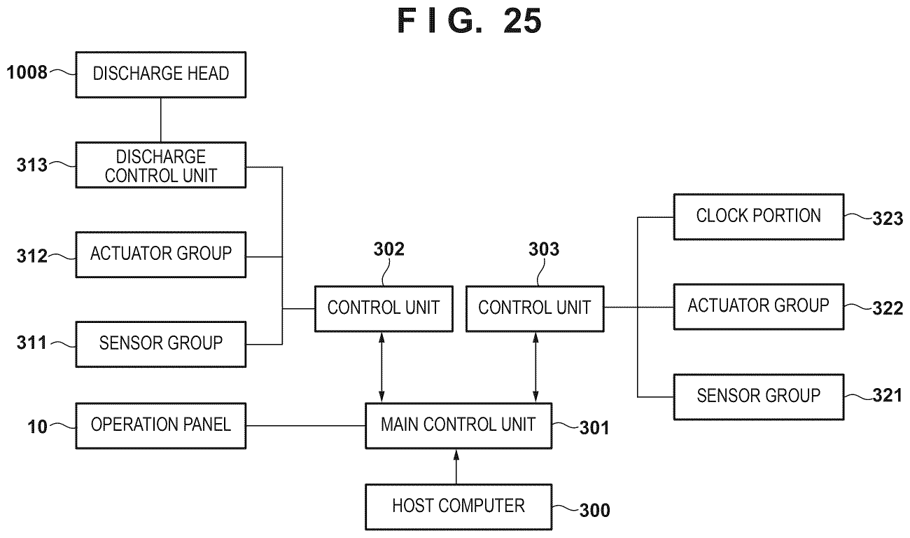

The configuration of the control circuit of the system A will be described with reference to FIG. 25. FIG. 25 is a block diagram of the control circuit of the system A. A main control unit 301 controls the entire system A in accordance with an instruction from a host computer 300 or the operation panel 10. A control unit 302 controls the liquid discharge apparatus 1 based on an instruction of the main control unit 301, and a control unit 303 controls the liquid supply apparatuses 20A and 20B based on an instruction of the main control unit 301. The main control unit 301 and the control units 302 and 303 each include, for example, at least one processor, at least one memory device, and at least one input/output interface. The memory device is, for example, a semiconductor memory such as a RAM or a ROM. The input/output interface performs input/output of signals between the processor and an external device (a sensor, a motor, or the like).

A discharge control unit 313 performs control of the discharge head 1008, particularly, discharge control of the liquid. An actuator group 312 includes a conveyance motor that is the driving source of the conveyance unit 1006, a carriage motor that is the driving source of the moving mechanism of a carriage (not shown), a winding motor that is the driving source of the winding unit 1005, and a recovery motor that is the driving source of the recovery unit 1009. The actuator group 312 further includes a cutter motor or the like that is the driving source of a cutter (not shown) configured to cut the print medium M after image printing. A sensor group 311 includes various kinds of sensors provided in the liquid discharge apparatus 1.

A clock portion 323 is a counter that outputs a count result of an elapsed time to the control unit 303. If a liquid stirring period is managed by time, the count result of the clock portion 323 can be used. Also, the stirring timing can be decided using the count result of the clock portion 323.

An actuator group 322 includes the motors 131 and 635, the passage valve 52, an actuator 29b, and the like. A sensor group 321 includes the operation button 25c, the sensor 26, the sensor 31, the sensor 38, and the like.

### Example of Processing of Control Circuit

### Execution Processing of Stirring Operation

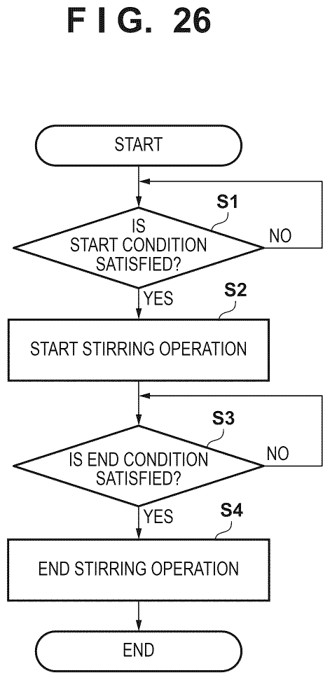

Concerning the stirring operation of the stirring unit 6, an example of processing executed by the control unit 303 will be described. FIG. 26 is a flowchart showing an example of processing executed by the control unit 303.

In step S1, it is determined whether a stirring start condition is satisfied. If the stirring start condition is satisfied, the process advances to step S2. The stirring start condition is, for example, arrival of a predetermined time of a day. Alternatively, the stirring start condition is that time elapsed from the end of the preceding stirring operation reaches a predetermined time. Alternatively, the stirring start condition is that the user instructs to perform stirring via the operation panel 10 or the like.

In step S2, the stirring operation is started. More specifically, the motor 635 is driven to drive the moving mechanism 63, thereby rotating the pressing member 60. The pressing portion 61 reciprocally moves between the pressing relaxing position and the pressing position, and the pressing operation and the pressing relaxing operation are repeated.

In step S3, it is determined whether an end condition is satisfied. If the end condition is satisfied, the process advances to step S4. In this embodiment, the end condition is elapse of a predetermined time T (to be also referred to as a reference time T). Another end condition is that the count of stirring operations reaches a predetermined count or the user instructs to end the stirring via the operation panel 10 or the like. In step S4, the stirring operation is ended. The processing is thus ended.

Note that an example of control of the stirring unit 6 has been described here, and the same applies to the stirring unit 100.

### Interruption and Resumption of Stirring Operation

If an operation associated with detachment of the container 200 is performed during the stirring operation, and the stirring operation is continued, it is difficult to detach the container 200. If the stirring operation is interrupted, stirring of the liquid in the container 200 is insufficient. If the insufficiently stirred liquid is used for printing, printing quality may be low.

In this embodiment, if an operation associated with detachment of the container 200 is performed during the stirring operation, the stirring operation is interrupted and, after that, processing associated with stirring resumption is performed. Examples of the operation associated with detachment of the container 200 are an operation of changing the state of one of the regulating mechanisms 46 in the liquid supply apparatus 20B from the regulating state to the regulation cancel state, that is, an operation of moving the slide member 461 to the unlock position by the user. When the slide member 461 moves to the unlock position, the user can extract the support unit 4 from the storage portion 23A. That is, the container 200 can be extracted from the storage portion 23A.

As a cause of the operation of moving the slide member 461 to the unlock position, three patterns are considered, that is, an operation error, exchange of the container 200, and detachment of the same container 200 are considered. In this embodiment, processing associated with resumption is executed selectively for these cases.

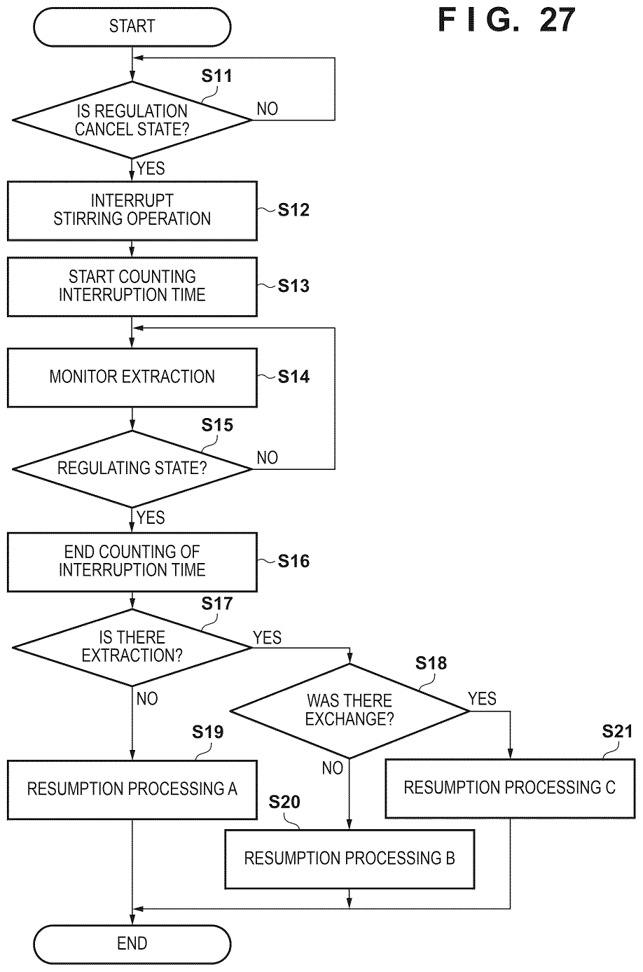

FIG. 27 is a flowchart showing an example of control of the stirring unit 6 executed by the control unit 303. This processing is executed during the stirring operation (during time from the start of step S2 in FIG. 26 until the end condition is satisfied in step S3).

In step S11, the detection result of the sensor 38 of each storage portion 23A having the stirring function is acquired, and it is determined whether there is the regulating mechanism 46 whose state is changed from the regulating state to the regulation cancel state. If there is the regulating mechanism 46 whose state is changed to the regulation cancel state, the process advances to step S12. Here, the storage portion 23A corresponding to the regulating mechanism 46 whose state is changed to the regulation cancel state is called the monitoring target storage portion 23A.

In step S12, the stirring operation under execution is interrupted. At this time, after the pressing member 60 moves to the pressing relaxing position, the motor 635 is stopped and the stirring operation is interrupted. This makes it easy for the user to extract the support unit 4 (container 200) from the monitoring target storage portion 23A. A remaining time with respect to the reference time T is stored. The remaining time is defined as time tr. In step S13, count of the interruption time is started using the clock portion 323.

In step S14, it is monitored whether the support unit 4 (container 200) is extracted from the monitoring target storage portion 23A. Here, for example, if the reader/writer 53 corresponding to the monitoring target storage portion 23A cannot read the memory of the container 200 anymore, it can be determined that the container 200 is extracted. Also, if the read of the memory is not possible anymore, and the read is then possible, it can be determined that the container 200 is stored. Thus, in this embodiment, the reader/writer 53 is also used as a storage detection sensor that detects whether the container 200 is stored in the storage portion 23A. However, a dedicated storage detection sensor may be provided separately from the reader/writer 53.

In step S15, the detection result of the sensor 38 corresponding to the monitoring target storage portion 23A is acquired, and it is determined whether the state of the regulating mechanism 46 corresponding to the monitoring target storage portion 23A is returned to the regulating state. Upon determining that the state is returned to the regulating state, the process advances to step S16. Otherwise, the process returns to step S14. In step S16, count of the interruption time using the clock portion 323 is ended. The interruption time is defined as ti.

In steps S17 and S18, case classification is performed. In step S17, it is determined, based on the monitoring result in step S14, whether the container 200 is extracted from the monitoring target storage portion 23A. If the container 200 is not extracted, it is considered that the operation detected in step S11 is an operation error of the user, and the process advances to step S19. If the container 200 is extracted, the process advances to step S18.

In step S18, the reader/writer 53 corresponding to the monitoring target storage portion 23A reads the memory of the container 200, and it is determined whether the container 200 stored in the monitoring target storage portion 23A is exchanged. If the same container 200 is stored, the process advances to step S20. If the container 200 is exchanged, the process advances to step S21.

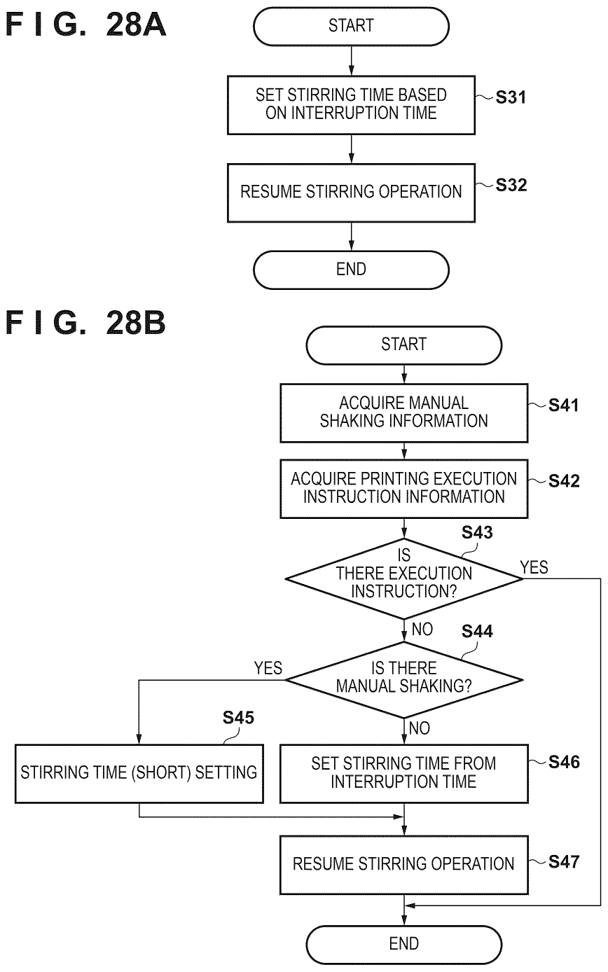

In step S19, resumption processing A is executed. The resumption processing A is processing in a case where the container 200 is not extracted from the monitoring target storage portion 23A. FIG. 28A is a flowchart showing an example. In step S31, a stirring time T′ after resumption is set based on the interruption time ti. The longer the interruption time ti is, the longer the stirring time T′ after resumption can be set. For example, stirring time T′=remaining time tr+(interruption time ti/constant) may hold. The constant may be a value of 1 or more.

In step S32, the stirring operation is resumed. The stirring operation is ended when the stirring time T′ set in step S31 elapses.

In step S20 of FIG. 27, resumption processing B is executed. The resumption processing B is processing in a case where the same container 200 is stored in the monitoring target storage portion 23A again. FIG. 28B is a flowchart showing an example. In step S41, manual shaking information is acquired. Manual shaking information is information indicating whether the user manually shakes the container 200 to stir the liquid inside and stores it in the monitoring target storage portion 23A again.

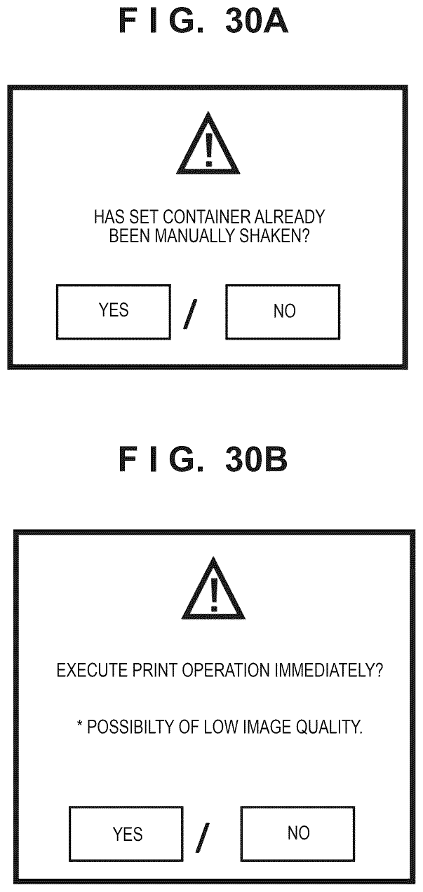

In this embodiment, an inquiry is made to the user as to whether he/she performs manual shaking, and an answer is acquired. FIG. 30A shows an example of display on the operation panel 10. In the example shown in FIG. 30A, a message “Has set container already been manually shaken?” is displayed. The user selects “Yes” or “No”. If “Yes” is selected, manual shaking information is set to “manual shaking”, and if “No” is selected, manual shaking information is set to “no manual shaking”.

In step S42 of FIG. 28B, printing execution instruction information is acquired. The printing execution instruction information is information indicating whether a printing operation execution instruction by the user exists. In this embodiment, particularly, this is intention confirmation information for confirming whether the user intends to immediately execute a print job.

In this embodiment, an inquiry is made to the user as to whether he/she intends to execute the print job immediately, and an answer is acquired. FIG. 30B shows an example of display on the operation panel 10. In the example shown in FIG. 30B, a message “Execute printing operation immediately?” is displayed. Also, as a note to the user, a message “Image quality may be low” is also displayed. This alerts the user to the possibility of low image quality if the printing operation is started in a state in which stirring of the liquid is insufficient. The user selects “Yes” or “No”. If “Yes” is selected, printing execution instruction information is set to “execution instruction”, and if “No” is selected, printing execution instruction information is set to “no execution instruction”.

In step S43 of FIG. 28B, it is determined, based on the printing execution instruction information acquired in step S42, whether there is an execution instruction. If there is an execution instruction, the processing is ended without resuming the stirring operation. After that, processing associated with execution of the printing operation is executed. In this embodiment, since the ink supply pressure to the discharge head 1008 may vary during stirring of the container 200, the printing operation is not performed. If there is no execution instruction, the process advances to step S44. In step S44, it is determined, based on the manual shaking information acquired in step S41, whether manual shaking is performed. If manual shaking is performed, the process advances to step S45. If manual shaking is not performed, the process advances to step S46.

In step S45, the stirring time T′ after resumption is set. Since the method or time of manual shaking by the user changes depending on the user, the distribution of the color material or the like of the liquid in the container 200 may be uneven. To improve the evenness of the liquid, the stirring time T′ after resumption is set to a predetermined time Ta without considering the interruption time ti or remaining time tr. The time Ta is shorter than the reference time T.

In step S46, the stirring time T′ after resumption is set. Since manual shaking by the user is not performed, sedimentation of the color material of the liquid in the container 200 may progress. The stirring time T′ after resumption is set based on the interruption time ti. The longer the interruption time ti is, the longer the stirring time T′ after resumption can be set. For example, stirring time T′=remaining time tr+(interruption time ti/constant) may hold. The constant may be a value of 1 or more.

In step S47, the stirring operation is resumed. The stirring operation is ended when the stirring time T′ set in step S45 or S46 elapses.

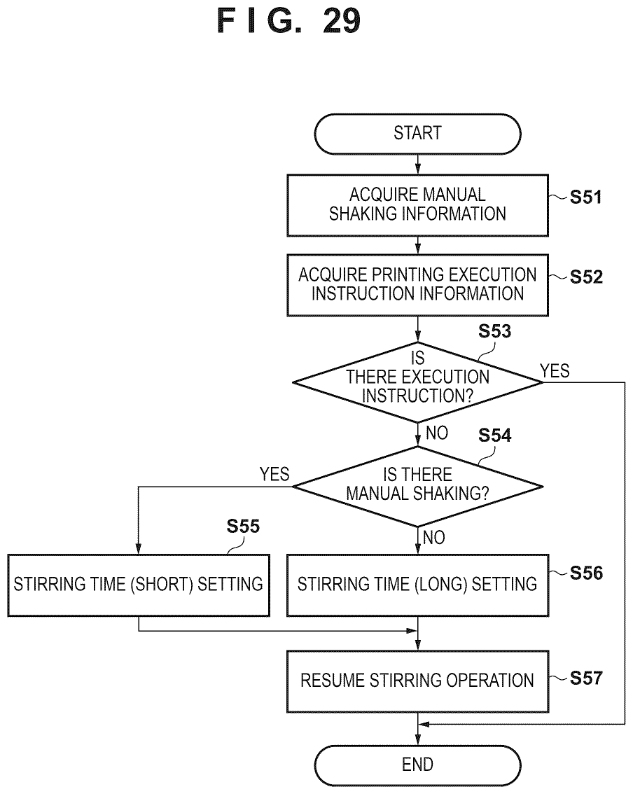

In step S21 of FIG. 27, resumption processing C is executed. The resumption processing C is processing in a case where the container 200 is exchanged. FIG. 29 is a flowchart showing an example. Processing of steps S51 to S54 is the same as the processing of steps S41 to S44 of the resumption processing B, and a description thereof will be omitted. Upon determining in step S54 that manual shaking is performed, the process advances to step S55. Upon determining that manual shaking is not performed, the process advances to step S56.

In step S55, the stirring time T′ after resumption is set. Since the method or time of manual shaking by the user changes depending on the user, the distribution of the color material or the like of the liquid in the container 200 may be uneven. In addition, since the container 200 is exchanged, the stirring is substantially new stirring rather than resumption of stirring. The interruption time ti or the remaining time tr need not be taken into consideration. The stirring time T′ after resumption is set to a predetermined time Tb. The time Tb is shorter than the reference time T.

In step S56, the stirring time T′ after resumption is set. Since manual shaking by the user is not performed, sedimentation of the color material of the liquid in the container 200 may progress. In addition, since the container 200 is exchanged, the stirring is substantially new stirring rather than resumption of stirring. The interruption time ti or the remaining time tr need not be taken into consideration. The stirring time T′ after resumption is set to a predetermined time Tc. The time Tc is longer than the time Tb and longer than the reference time T.

In step S57, the stirring operation is resumed. The stirring operation is ended when the stirring time T′ set in step S55 or S56 elapses.

The processing is thus ended. As described above, in this embodiment, if an operation associated with detachment of the container 200 is performed during the stirring operation, the stirring operation is interrupted. Hence, the user can easily extract the container 200. Also, to resume the stirring operation, cases such as detachment of the container 200 and the presence/absence of exchange are classified, and one of the resumption processing A to C is selected. It is therefore possible to resume the stirring operation in accordance with the case.

### Notification to User

If the stirring operation is interrupted, sedimentation of the color material or the like contained in the liquid in the container 200 progresses. To suppress this, in this embodiment, the user is notified of this such that the stirring operation can be resumed in a short time or the stirring operation is not interrupted.

### Notification Example 1

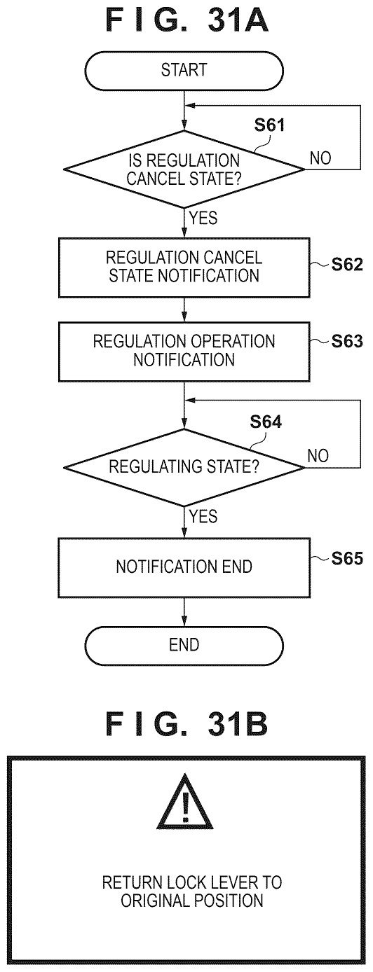

FIG. 31A is a flowchart showing an example of processing associated with notification executed by the control unit 303. This processing is executed during the stirring operation (during time from the start of step S2 in FIG. 26 until the end condition is satisfied in step S3).

In step S61, the detection result of the sensor 38 of each storage portion 23A having the stirring function is acquired, and it is determined whether there is the regulating mechanism 46 whose state is changed from the regulating state to the regulation cancel state. If there is the regulating mechanism 46 whose state is changed to the regulation cancel state, the process advances to step S62. Like the first embodiment, the storage portion 23A corresponding to the regulating mechanism 46 whose state is changed to the regulation cancel state is called the monitoring target storage portion 23A.

In step S62, the user is notified that the regulating mechanism 46 corresponding to the monitoring target storage portion 23A is in the regulation cancel state. Here, the state indicator 33 corresponding to the monitoring target storage portion 23A is driven in a predetermined mode, thereby notifying the user that the regulating mechanism 46 is in the regulation cancel state.

In step S63, a notification is made to promote the user to perform an operation of returning the regulating mechanism 46 to the regulating state. This notification can be made by the operation panel 10. FIG. 31B shows an example. In the example shown in FIG. 31B, a message “Return lock lever to original position” is displayed, thereby promoting the user to perform an operation of returning the slide member 461 to the lock position.

In step S64 of FIG. 31A, the detection result of the sensor 38 corresponding to the monitoring target storage portion 23A is acquired, and it is determined whether the state of the regulating mechanism 46 corresponding to the monitoring target storage portion 23A is returned to the regulating state. Upon determining that the state is returned to the regulating state, the process advances to step S65. In step S65, the notification is ended.

With the above-described processing, the stirring operation is resumed in a short time, and progress of sedimentation of the color material or the like contained in the liquid fin the container 200 can be suppressed.

### Notification Example 2

If a condition for recommending exchange of the container 200 is satisfied by, for example, a decrease of the remaining amount of the liquid in the container 200, a notification is made to promote the user to exchange the container 200, thereby promoting exchange. On the other hand, if such a notification is made during the stirring operation of the container 200, the stirring operation is interrupted. Hence, the notification to promote exchange of the container 200 may be inhibited during the stirring operation.

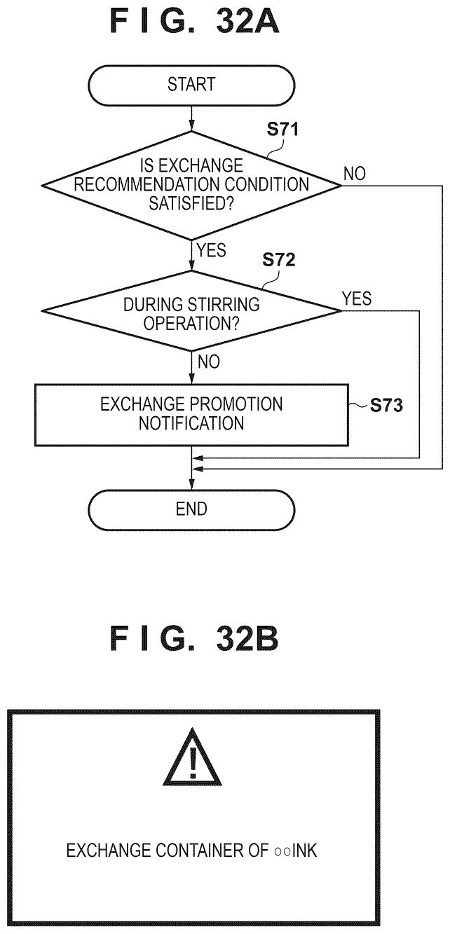

FIG. 32A is a flowchart showing an example of processing associated with notification executed by the control unit 303, and this processing is repetitively performed at a predetermined period.

In step S71, it is determined whether the exchange recommendation condition is satisfied for any one of the containers 200 stored in the storage portions 23A of the liquid supply apparatus 20B. The exchange recommendation condition is that, for example, the remaining amount of the liquid in the container 200 decreases to less than a threshold. The remaining amount can be specified from the detection result of the remaining amount detection sensor 31 or the discharge amount of the liquid in the container 200 by the discharge head 1008. The containers 200 that are the target of the determination include the containers 200 that are stored in the storage portions 23A without the stirring function. Upon determining that the exchange recommendation condition is satisfied, the process advances to step S72. Upon determining that the exchange recommendation condition is not satisfied, the processing is ended.

In step S72, it is determined whether the stirring operation of the stirring unit 6 is being performed. If the stirring operation is not being performed, the process advances to step S73. In step S73, exchange promotion notification of the container 200 is performed. This notification can be made by the operation panel 10. FIG. 32B shows an example. In the example shown in FIG. 32B, a message “Exchange container of ◯ ◯ ink” is displayed. The container 200 that is the exchange target is specified, and the user is promoted to exchange this. Note that the notification may be performed by driving the state indicator 33 corresponding to the storage portion 23A storing the container 200 as the exchange target in a predetermined mode in place of or in addition to display on the operation panel 10.

Upon determining in step S72 that the stirring operation is being performed, the process skips step S73, and the processing is ended. Exchange promotion notification of the container 200 is not performed. The exchange promotion notification is performed at another timing that is not during the stirring operation. Hence, the user is prevented from performing the regulation cancel operation of the regulating mechanism 46 because of the exchange promotion notification.

### Notification Example 3

The user may be notified not to extract the container 200 stored in the storage portion 23A during the stirring operation.

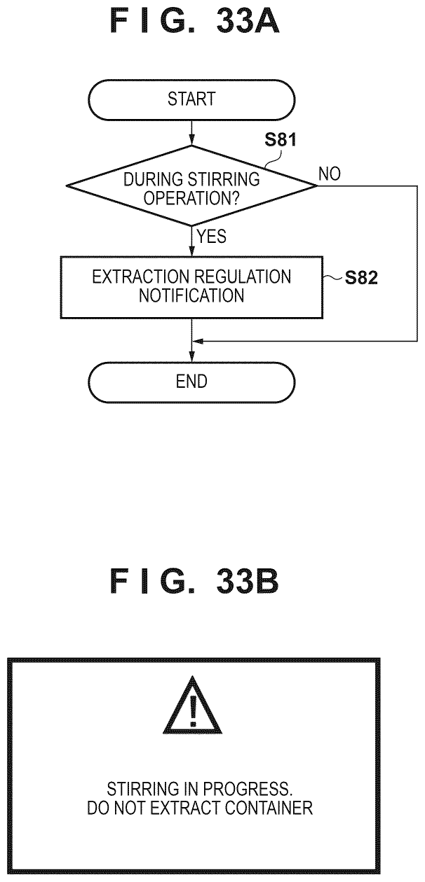

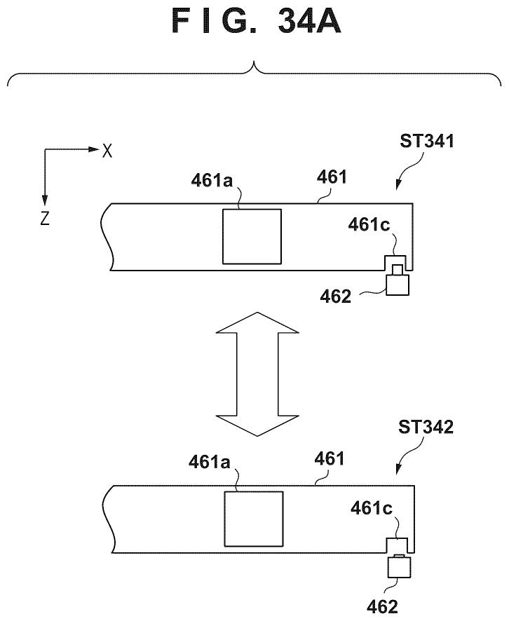

FIG. 33A is a flowchart showing an example of processing associated with notification executed by the control unit 303, and this processing is repetitively performed at a predetermined period.

In step S81, it is determined whether the stirring operation of the stirring unit 6 is being performed. If the stirring operation is not being performed, the processing is ended. If the stirring operation is being performed, the process advances to step S82. In step S82, an extraction regulation notification is made. This notification can be made by the operation panel 10. FIG. 33B shows an example. In the example shown in FIG. 33B, a message “Stirring in progress. Do not extract container” is displayed to notify the user no to extract the container 200 stored in the storage portion 23A. Hence, the user is prevented from performing the regulation cancel operation of the regulating mechanism 46 during the stirring operation of the stirring unit 6.

With the above-described notification, it is possible to resume the stirring operation in a short time or prevent the stirring operation from being interrupted.

### Second Embodiment

In the resumption processing B (step S20, FIG. 28B) according to the first embodiment, if the printing execution instruction information indicates that an execution instruction exists, the printing operation is executed without resuming the stirring operation (YES in step S43 of FIG. 28B). Instead, the printing operation may be executed after the stirring operation is performed for a short time. In this case, a time T″ of the stirring operation may be shorter than in a case where the printing execution instruction information indicates that there is no execution instruction. For example, for a time T′ (=Ta) set in step S45 of FIG. 28B, the time T″ may satisfy T″<Ta. In addition, for a time T′ (=remaining time tr+(interruption time ti/constant)) set in step S46 of FIG. 28B, the time T″may satisfy T″<tr.

The same applies to the resumption processing C (step S21, FIG. 29) according to the first embodiment. In the example shown in FIG. 29, if the printing execution instruction information indicates that an execution instruction exists, the printing operation is executed without resuming the stirring operation (YES in step S53 of FIG. 29). Instead, the printing operation may be executed after the stirring operation is performed for a short time. In this case, the time T″ of the stirring operation may be shorter than in a case where the printing execution instruction information indicates that there is no execution instruction. For example, for the time T′ (=Tb) set in step S55 of FIG. 29, the time T″ may satisfy T″<Tb. In addition, for the time T′ (=Tc) set in step S56 of FIG. 29, the time T″ may satisfy T″<Tc.

### Third Embodiment

In the first and second embodiments, the processing examples shown in FIGS. 27 to 29 and the processing examples of notification examples 1 to 3 have been described assuming that the storage portion 23A and the stirring unit 6 are the targets. The same processes can be applied to a storage portion 23B and a stirring unit 100 as well. In this case, the operation associated with detachment of a container 200 is an unlock operation of an opening/closing member 25 (an operation for an operation button 25c). The target to detect regulation cancel and regulating states in steps S11 and S15 of FIG. 27 and steps S61 and S64 of FIG. 31A is a regulating mechanism 29. The remaining processes are basically the same as in the example of the storage portion 23A and the stirring unit 6. If the stirring operation is interrupted in step S12 of FIG. 27, a container unit 110 is stopped at the initial position (state ST141 in FIG. 24), and the user can thus easily exchange the container 200.

### Fourth Embodiment

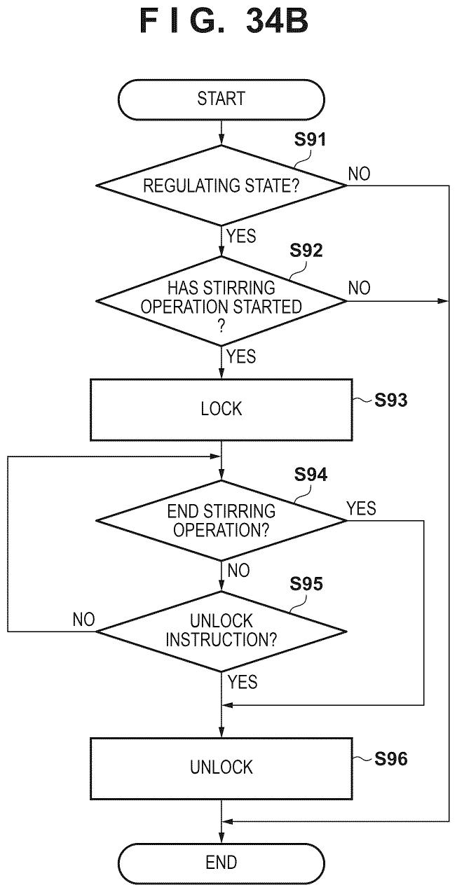

In the first embodiment, a configuration that inhibits the state of the regulating mechanism 46 from being set in the regulation cancel state during the stirring operation may be provided. FIG. 34A is an explanatory view of a lock mechanism 462 of a slide member 461. The lock mechanism 462 is provided in each storage portion 23A having a stirring function.

An engaging portion 461c is formed on the slide member 461. The engaging portion 461c is a concave portion. The lock mechanism 462 is, for example, a solenoid and is arranged such that its movable portion (plunger) can engage with the engaging portion 461c.

A state ST341 indicates a case where the lock mechanism 462 is in a locked state. Since the movable portion of the lock mechanism 462 enters the engaging portion 461c, the slide member 461 cannot be slid in the X direction. A state ST342 indicates a case where the lock mechanism 462 is in an unlocked state. Since the movable portion of the lock mechanism 462 does not enter the engaging portion 461c, the slide member 461 can be slid in the X direction.

FIG. 34B is a flowchart showing an example of control of the lock mechanism 462 executed by a control unit 303, and this processing is repetitively executed at a predetermined period.

In step S91, the detection result of a sensor 38 of each storage portion 23A having the stirring function is acquired, and it is determined whether all regulating mechanisms 46 are in the regulating state. If all regulating mechanisms 46 are in the regulating state, the process advances to step S92. Otherwise, the processing is ended.

In step S92, it is determined whether a stirring operation by a stirring unit 6 is started. If the stirring operation is started, the process advances to step S93. If the stirring operation is not started, the processing is ended. In step S93, the state of each lock mechanism 462 is set to the locked state. The slide member 461 cannot slide, and the user cannot slide the slide member 461 to the unlock position. That is, setting the regulating mechanism 46 to the regulation cancel state is regulated. In step S94, it is determined whether the stirring operation by the stirring unit 6 is ended. If the stirring operation is ended, the process advances to step S96. If the stirring operation is not ended, the process advances to step S95.

Here, if the lock mechanism 462 is in the locked state, the user cannot extract a container 200 from the storage portion 23A. However, there is also assumed a case where the user wants to extract the container 200 even during the stirring operation because of special circumstances. In this embodiment, lock of the lock mechanism 462 can forcibly be canceled by a user operation on an operation panel 10. That is, in step S95, it is determined whether an instruction from the user exists concerning unlock of the lock mechanism 462. If an unlock instruction is input via the operation panel 10, the process advances to step S96. If an unlock instruction is not input, the process returns to step S94.

In step S96, the state of each lock mechanism 462 is set to the unlocked state. The processing is thus ended. According to this embodiment, it is possible to more reliably prevent the stirring operation from being interrupted.

Note that the same processing as in this embodiment can be applied to a storage portion 23B. A regulating mechanism 29 of the storage portion 23B is changed to the regulating state and the regulation cancel state by a user operation on an operation button 25c. During the stirring operation, even if the user operation on the operation button 25c is performed, interruption of the stirring operation can be prevented by inhibiting change of the regulating mechanism 29 to the regulation cancel state. In this case, the regulating mechanism 29 may forcibly be changed to the regulation cancel state by the user operation on the operation panel 10.

### Fifth Embodiment

Liquid leakage may occur in the path from a container 200 to a discharge head 1008. If liquid leakage occurs in a certain point of the path of the liquid, leakage of the liquid may be promoted by the stirring operation of the liquid. An embodiment that prevents liquid leakage from being promoted by the stirring operation of the liquid will be described.

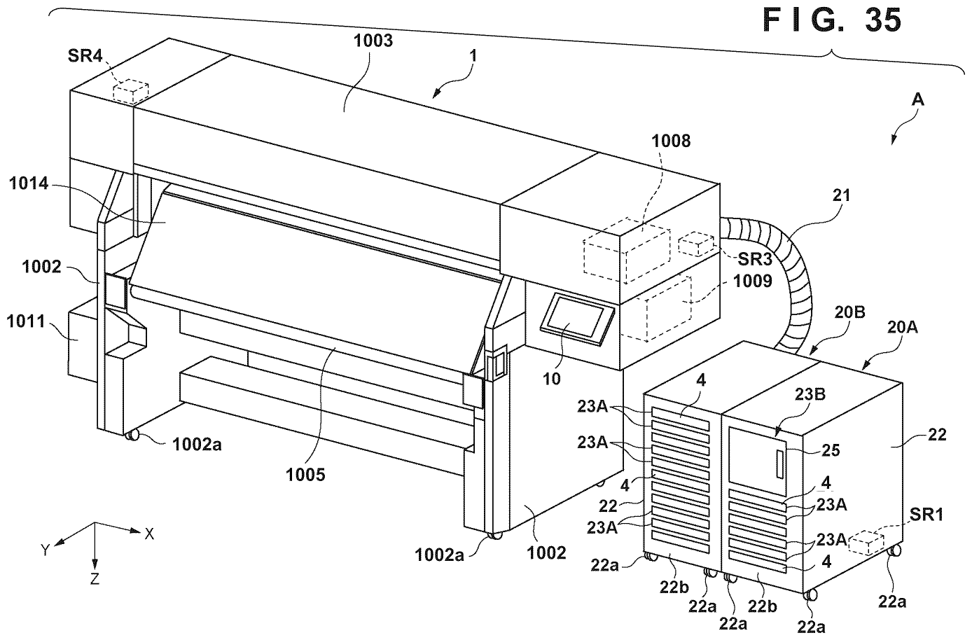

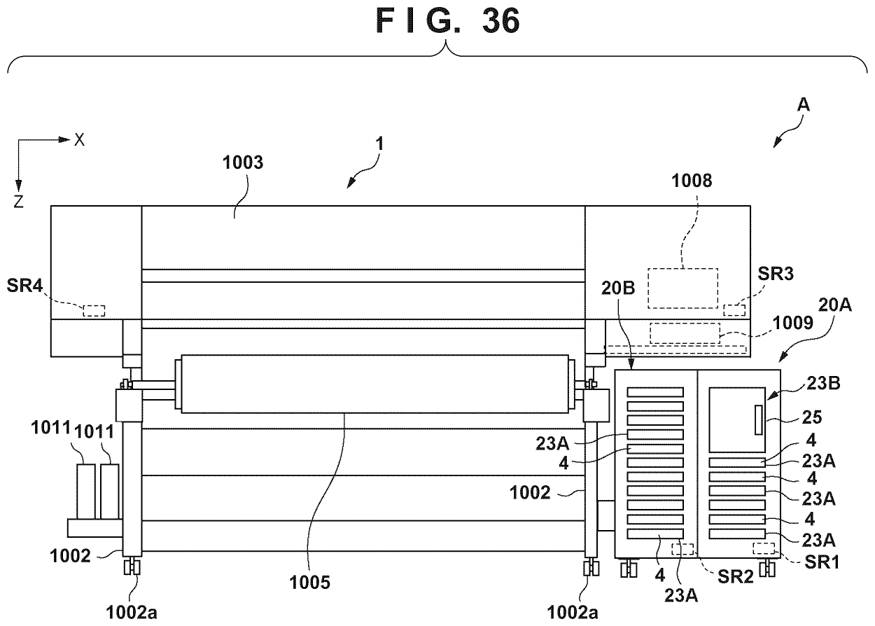

FIGS. 35 and 36 show an example in which sensors are arranged in a system A. The system A is provided with leakage detection sensors SR1 to SR4 each configured to detect liquid leakage. The leakage detection sensors SR1 to SR4 can use any detection method if these are sensors capable of detecting the presence/absence of a liquid. As an example, the leakage detection sensors SR1 to SR4 may each be a sensor including a pair of electrodes arranged to be immersed in a place where the leaked liquid stays and configured to detect the presence/absence of the liquid based on a change of the resistance value between the pair of electrodes.

The leakage detection sensor SR1 is arranged to detect liquid leakage in a liquid supply apparatus 20A. In this embodiment, the leakage detection sensor SR1 is arranged on the bottom portion of the liquid supply apparatus 20A to detect the liquid that leaks and flows down from storage portions 23A and 23B and stays on the bottom portion of the liquid supply apparatus 20A. A liquid pool where the leaked liquid stays may be formed on the bottom portion. The liquid pool may have, for example, a form of a concave portion, and the bottom surface on the periphery may tilt down toward the concave portion.

The leakage detection sensor SR2 is arranged to detect liquid leakage in a liquid supply apparatus 20B. In this embodiment, the leakage detection sensor SR2 is arranged on the bottom portion of the liquid supply apparatus 20B to detect the liquid that leaks and flows down from the storage portions 23A and stays on the bottom portion of the liquid supply apparatus 20B. A liquid pool where the leaked liquid stays may be formed on the bottom portion. The liquid pool may have, for example, a form of a concave portion, and the bottom surface on the periphery may tilt down toward the concave portion.

The leakage detection sensors SR3 and SR4 are arranged to detect liquid leakage in a liquid discharge apparatus 1. In this embodiment, the leakage detection sensors SR3 and SR4 are arranged on the bottom portion of a main body 1003 to detect the liquid that leaks and flows down in the main body 1003 and stays on the bottom portion. A liquid pool where the leaked liquid stays may be formed on the bottom portion. The liquid pool may have, for example, a form of a concave portion, and the bottom surface on the periphery may tilt down toward the concave portion.

The leakage detection sensors SR3 and SR4 detect liquid leakage at different positions. In this embodiment, the leakage detection sensors SR3 and SR4 are arranged apart in the reciprocal moving direction (X direction) of the discharge head 1008. The leakage detection sensor SR3 is arranged on the home position side of the discharge head 1008, and the leakage detection sensor SR4 is arranged on the back position side of the discharge head 1008.

As compared to the leakage detection sensor SR4, the leakage detection sensor SR3 is arranged at a position closer to the joint portion between a hose 21 and the main body 1003. If liquid leakage occurs in the joint portion, the leakage detection sensor SR3 readily detects this. The leakage detection sensor SR4 is arranged on the back position side of the discharge head 1008. Hence, if the tube disengages from the discharge head 1008 to cause liquid leakage because of movement of the discharge head 1008, the leakage detection sensor SR4 readily detects this.

If liquid leakage is detected by the leakage detection sensors SR1 to SR4, the user can be notified of the occurrence of the leakage. The notification may be made by an operation panel 10.

In this embodiment, in the control circuit described with reference to FIG. 25, a sensor group 311 includes the leakage detection sensors SR3 and SR4. The detection results of the leakage detection sensors SR3 and SR4 are provided to a control unit 303 via a control unit 302 and a main control unit 301. A sensor group 321 includes the leakage detection sensors SR1 and SR2. The detection results of the leakage detection sensors SR1 and SR2 are acquired by the control unit 303.

### Liquid Leakage and Regulation of Stirring Operation

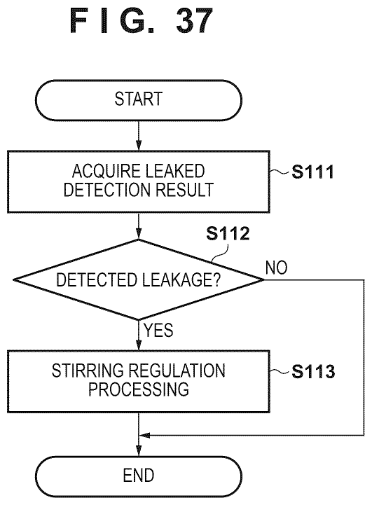

If the stirring operation is performed in a situation in which liquid leakage occurs, pressurization on the liquid in the path by stirring may promote liquid leakage. In this embodiment, if liquid leakage is detected, stirring is regulated. FIG. 37 is a flowchart showing an example of processing executed by the control unit 303. The processing shown in FIG. 37 is executed periodically and repetitively.

In step S111, the detection results of the leakage detection sensors SR1 to SR4 are acquired. In step S112, it is determined, based on the detection results acquired in step S111, whether liquid leakage is detected by one of the leakage detection sensors SR1 to SR4. Upon determining that leakage is detected, the process advances to step S113.

In step S113, stirring regulation processing is performed. In the stirring regulation processing, processing of regulating the stirring operation of stirring units 6 and 100 is performed. In this embodiment, the leakage detection sensors SR1 to SR4 are arranged to detect liquid leakage at different points. For this reason, control contents are determined based on which one of the leakage detection sensors SR1 to SR4 is the sensor that detects the leakage.

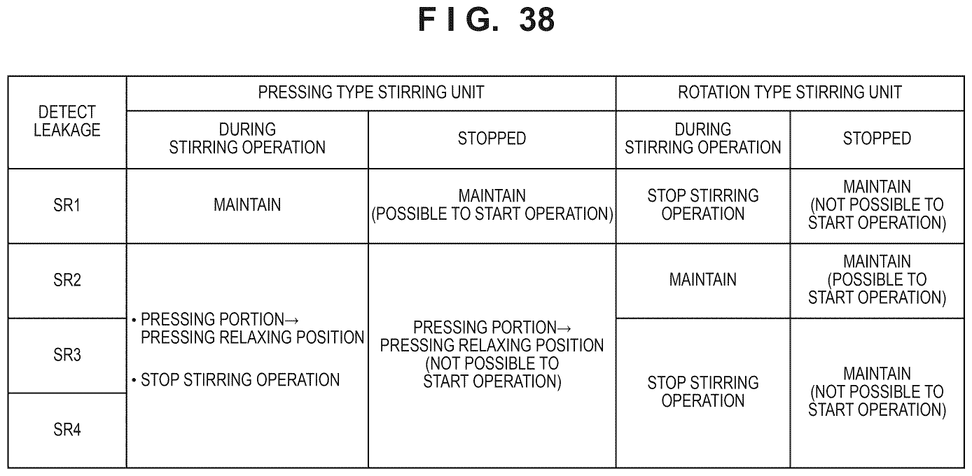

FIG. 38 is a view showing control contents in stirring regulation processing. In FIG. 38, “pressing type stirring unit” indicates control contents for the stirring unit 6, and “rotation type stirring unit” indicates control contents for the stirring unit 100. “Liquid leakage” indicates a sensor determined to have detected liquid leakage among the leakage detection sensors SR1 to SR4.

A case where leakage is detected by the leakage detection sensor SR1 will be described first. The leakage detection sensor SR1 detects liquid leakage in the liquid supply apparatus 20A. The cause of liquid leakage is estimated to be in the liquid supply apparatus 20A. If the stirring unit 100 provided in the liquid supply apparatus 20A is performing the stirring operation, the stirring operation is stopped as regulation. Also, if the stirring unit 100 is stopped, the stop state is maintained. In addition, even if the stirring start condition is formally satisfied, the stirring operation is not started. On the other hand, the stirring unit 6 provided in the liquid supply apparatus 20B is not the target of regulation, and if the stirring operation is being performed, the operation is continued. If the stirring unit 6 is stopped, the stop state is maintained. In addition, if the stirring start condition is satisfied, the stirring operation is started.

A case where leakage is detected by the leakage detection sensor SR2 will be described next. The leakage detection sensor SR2 detects liquid leakage in the liquid supply apparatus 20B. The cause of liquid leakage is estimated to be in the liquid supply apparatus 20B. If the stirring unit 6 provided in the liquid supply apparatus 20B is performing the stirring operation, the stirring operation is stopped as regulation. If the stirring operation is stopped in a state in which the container 200 is pressed by a pressing portion 61, the liquid in the container 200 is pressurized, and liquid leakage may be promoted. Hence, when stopping the stirring operation, the stirring operation is stopped after the pressing portion 61 is located at the pressing relaxing position. Also, if the stirring unit 6 is stopped, the stop state is maintained. At this time, if the pressing portion 61 is stopped at the pressing position, it is moved to the pressing relaxing position. Even if the stirring start condition is formally satisfied, the stirring operation is not started.

On the other hand, the stirring unit 100 provided in the liquid supply apparatus 20A is not the target of regulation, and if the stirring operation is being performed, the operation is continued. If the stirring unit 100 is stopped, the stop state is maintained. In addition, if the stirring start condition is satisfied, the stirring operation is started.

A case where leakage is detected by the leakage detection sensor SR3 or SR4 will be described next. The leakage detection sensor SR3 or SR4 detects liquid leakage in the main body 1003 of the liquid discharge apparatus 1. The cause of liquid leakage is estimated to be in the main body 1003, and both the stirring unit 6 and the stirring unit 100 are the targets of regulation.

If the stirring unit 6 is performing the stirring operation, the stirring operation is stopped as regulation. If the stirring operation is stopped in a state in which the container 200 is pressed by the pressing portion 61, the liquid in the container 200 is pressurized, and liquid leakage may be promoted. Hence, when stopping the stirring operation, the stirring operation is stopped after the pressing portion 61 is located at the pressing relaxing position. Also, if the stirring unit 6 is stopped, the stop state is maintained. At this time, if the pressing portion 61 is stopped at the pressing position, it is moved to the pressing relaxing position. Even if the stirring start condition is formally satisfied, the stirring operation is not started.

If the stirring unit 100 is performing the stirring operation, the stirring operation is stopped as regulation. Also, if the stirring unit 100 is stopped, the stop state is maintained. Even if the stirring start condition is formally satisfied, the stirring operation is not started. As for the stirring unit 100, since the pressurization force to the liquid is not largely varied by the posture of a container unit 110 during the stop, the rotation position of the container unit 110 is not changed.

With the above-described control, the operations of the stirring units 6 and 100 can be regulated in accordance with the position of occurrence of liquid leakage, and promotion of liquid leakage can be prevented.

### Sixth Embodiment

If a liquid is supplied from a liquid supply apparatus 20 to a liquid discharge apparatus 1, as in a case where a print job is being executed, a pressure loss occurs in the path. If the pressure loss is larger than the pressurization force to the liquid by a stirring operation, a pressure variation caused in the path by the stirring operation of a stirring unit 6 or a stirring unit 100 does not reach beyond a certain point on the path.

A leakage detection sensor SR3 described in the fifth embodiment is arranged at a position close to the joint portion between a hose 21 and a main body 1003. Hence, if leakage is detected by the leakage detection sensor SR3, the occurrence point is estimated to be on the path on the downstream side (the side of a discharge head 1008) from the joint portion. Let P1 be the pressure loss from a connecting unit 50 of a liquid supply apparatus 20A or 20B to the joint portion between the hose 21 and the main body 1003. The pressure loss P1 can be specified from the flow amount of the liquid or the path diameter and the path length. Due to the specifications of a system A, if the pressure of the liquid by the stirring operation is equal to or less than the pressure loss P1, continuing the stirring operation promotes the leakage little.

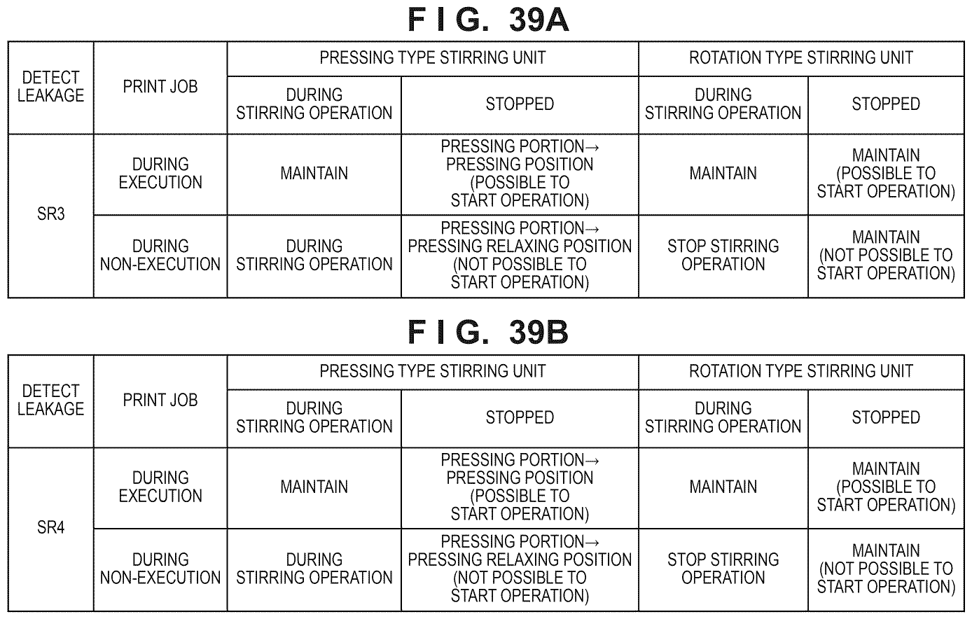

FIG. 39A is a view showing control contents in stirring regulation processing in a case where liquid leakage is detected by the leakage detection sensor SR3, assuming that the pressure of the liquid by the stirring operation is equal to or less than the pressure loss P1 due to the specifications of the system A. More specifically, the pressing force in the pressing operation of the stirring unit 6 is assumed to be equal to or less than the pressure loss P1. In addition, the pressurization force acting on the liquid in the stirring operation by the stirring unit 100 is assumed to be equal to or less than the pressure loss P1. The control contents shown in FIG. 39A can be applied in place of the control contents in a case where the leakage detection sensor SR3 detects leakage in the example shown in FIG. 38. Conversely, it can be said that control contents in the case where the leakage detection sensor SR3 detects leakage in FIG. 38 assume that the pressure of the liquid by the stirring operation exceeds the pressure loss P1.

In the example shown in FIG. 39A, the control contents change depending on whether a print job is being executed. During execution of a print job, since the liquid is supplied from the liquid supply apparatus 20 to the liquid discharge apparatus 1, the pressure loss P1 occurs in the path from the connecting unit 50 of the liquid supply apparatus 20A or 20B to the joint portion between the hose 21 and the main body 1003.

If the stirring unit 6 is executing the stirring operation, regulation is not performed, and the stirring operation is continued. Also, in a stop state, to prevent air from mixing into the liquid in the path, if the pressing portion 61 is stopped at the pressing relaxing position, it is moved to the pressing position. If the stirring start condition is satisfied, the stirring operation is started.

If the stirring unit 100 is executing the stirring operation, regulation is not performed, and the stirring operation is continued. If the stirring operation is stopped, the stop state is maintained, and if the stirring start condition is satisfied, the stirring operation is started. In the stirring unit 100, since the pressurization force to the liquid does not largely vary depending on the posture of a container unit 110 during the stop, the rotation position of the container unit 110 is not changed.

During non-execution of a print job, the liquid is not supplied or may not be supplied from the liquid supply apparatus 20 to the liquid discharge apparatus 1. The pressure loss P1 may not occur in the path from the connecting unit 50 of the liquid supply apparatus 20A or 20B to the joint portion between the hose 21 and the main body 1003. For this reason, the same control contents as the control contents shown in FIG. 38 are employed.

That is, if the stirring unit 6 is executing the stirring operation, the stirring operation is stopped as regulation. If the stirring operation is stopped in a state in which a container 200 is pressed by a pressing portion 61, the liquid in the container 200 is pressurized, and liquid leakage may be promoted. Hence, when stopping the stirring operation, the stirring operation is stopped after the pressing portion 61 is located at the pressing relaxing position. Also, if the stirring unit 6 is stopped, the stop state is maintained. At this time, if the pressing portion 61 is stopped at the pressing position, it is moved to the pressing relaxing position. Even if the stirring start condition is formally satisfied, the stirring operation is not started.

If the stirring unit 100 is executing the stirring operation, the stirring operation is stopped as regulation. Also, if the stirring unit 100 is stopped, the stop state is maintained. In addition, even if the stirring start condition is formally satisfied, the stirring operation is not started. In the stirring unit 100, since the pressurization force to the liquid does not largely vary depending on the posture of the container unit 110 during the stop, the rotation position of the container unit 110 is not changed.

With the above-described control, the operation of the stirring units 6 and 100 can be regulated in accordance with the pressure loss in the path or the operation state of the liquid discharge apparatus 1, and promotion of liquid leakage can be prevented.

The same applies to a leakage detection sensor SR4. The leakage detection sensor SR4 is arranged on the back position side of the discharge head 1008. Hence, if leakage is detected by the leakage detection sensor SR4, the occurrence point is estimated to be on the path near the discharge head 1008. Let P2 be the pressure loss from the connecting unit 50 of the liquid supply apparatus 20A or 20B to the discharge head 1008. The pressure loss P2 can be specified from the flow amount of the liquid or the path diameter and the path length. Normally, P1<P2 holds. Due to the specifications of the system A, if the pressure of the liquid by the stirring operation is equal to or less than the pressure loss P2, continuing the stirring operation promotes the leakage little.

FIG. 39B is a view showing control contents in stirring regulation processing in a case where liquid leakage is detected by the leakage detection sensor SR4, assuming that the pressure of the liquid by the stirring operation is equal to or less than the pressure loss P2 due to the specifications of the system A. More specifically, the pressing force in the pressing operation of the stirring unit 6 is assumed to be equal to or less than the pressure loss P2. In addition, the pressurization force acting on the liquid in the stirring operation by the stirring unit 100 is assumed to be equal to or less than the pressure loss P2. The control contents shown in FIG. 39B can be applied in place of the control contents in a case where the leakage detection sensor SR4 detects leakage in the example shown in FIG. 38. Conversely, it can be said that control contents in the case where the leakage detection sensor SR4 detects leakage in FIG. 38 assume that the pressure of the liquid by the stirring operation exceeds the pressure loss P2.

In the example shown in FIG. 39B, the control contents change depending on whether a print job is being executed. During execution of a print job, since the liquid is supplied from the liquid supply apparatus 20 to the liquid discharge apparatus 1, the pressure loss P2 occurs in the path from the connecting unit 50 of the liquid supply apparatus 20A or 20B to the joint portion between the hose 21 and the main body 1003.

If the stirring unit 6 is executing the stirring operation, regulation is not performed, and the stirring operation is continued. Also, in a stop state, to prevent air from mixing into the liquid in the path, if the pressing portion 61 is stopped at the pressing relaxing position, it is moved to the pressing position. If the stirring start condition is satisfied, the stirring operation is started.

If the stirring unit 100 is executing the stirring operation, regulation is not performed, and the stirring operation is continued. If the stirring operation is stopped, the stop state is maintained, and if the stirring start condition is satisfied, the stirring operation is started. In the stirring unit 100, since the pressurization force to the liquid does not largely vary depending on the posture of the container unit 110 during the stop, the rotation position of the container unit 110 is not changed.

During non-execution of a print job, the liquid is not supplied or may not be supplied from the liquid supply apparatus 20 to the liquid discharge apparatus 1. The pressure loss P2 may not occur in the path from the connecting unit 50 of the liquid supply apparatus 20A or 20B to the joint portion between the hose 21 and the main body 1003. For this reason, the same control contents as the control contents shown in FIG. 38 are employed.

That is, if the stirring unit 6 is executing the stirring operation, the stirring operation is stopped as regulation. If the stirring operation is stopped in a state in which the container 200 is pressed by the pressing portion 61, the liquid in the container 200 is pressurized, and liquid leakage may be promoted. Hence, when stopping the stirring operation, the stirring operation is stopped after the pressing portion 61 is located at the pressing relaxing position. Also, if the stirring unit 6 is stopped, the stop state is maintained. At this time, if the pressing portion 61 is stopped at the pressing position, it is moved to the pressing relaxing position. Even if the stirring start condition is formally satisfied, the stirring operation is not started.

If the stirring unit 100 is executing the stirring operation, the stirring operation is stopped as regulation. Also, if the stirring unit 100 is stopped, the stop state is maintained. In addition, even if the stirring start condition is formally satisfied, the stirring operation is not started. In the stirring unit 100, since the pressurization force to the liquid does not largely vary depending on the posture of the container unit 110 during the stop, the rotation position of the container unit 110 is not changed.

With the above-described control, the operation of the stirring units 6 and 100 can be regulated in accordance with the pressure loss in the path or the operation state of the liquid discharge apparatus 1, and promotion of liquid leakage can be prevented.

### Seventh Embodiment

In the fifth and sixth embodiments, stop has been exemplified as the regulation of the stirring operation. However, for example, lowering stirring performance may be contents of regulation. As the lowering of stirring performance, decreasing the frequency, reducing the operation speed, or making of the operation stroke small can be exemplified.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2024-189200, filed Oct. 28, 2024, and No. 2024-192417, filed Oct. 31, 2024, which are hereby incorporated by reference herein in their entirety.

What is claimed is:

1. A stirring apparatus comprising:
a storage portion configured to store a container;
a stirring unit configured to perform a stirring operation for the container stored in the storage portion such that a liquid contained in the container is stirred;
a regulating unit whose state changes between a regulating state in which extraction of the container from the storage portion is regulated and a regulation cancel state; and
a control unit configured to control the stirring unit,
wherein the control unit is configured to:
interrupt the stirring operation upon determining that the state of the regulating unit changes from the regulating state to the regulation cancel state during the stirring operation, and
resume the stirring operation upon determining that the state of the regulating unit changes from the regulation cancel state to the regulating state during the interruption of the stirring operation.

2. The apparatus according to claim 1, wherein
the stirring operation is an operation of repeating a pressing operation and a pressing relaxing operation for the container, and
when interrupting the stirring operation, the stirring operation is interrupted after the pressing relaxing operation.

3. The apparatus according to claim 1, wherein
the stirring operation is an operation of rotating the container, and
the interruption of the stirring operation is stop of the rotation of the container.

4. The apparatus according to claim 1, wherein
the control unit is configured to control the stirring operation after the resumption based on an interruption time over which the stirring operation is interrupted.

5. The apparatus according to claim 4, wherein
the control unit is configured to control time of the stirring operation after the resumption longer as the interruption time becomes longer.

6. The apparatus according to claim 1, wherein
the control unit is configured to:
acquire information indicating whether the container stored in the storage portion has already been manually shaken by a user; and
control the stirring operation after the resumption based on the acquired information.

7. The apparatus according to claim 6, wherein
if the acquired information indicates that the container has already been manually shaken, the control unit is configured to control the time of the stirring operation after the resumption shorter than in a case where the container has not been manually shaken yet.

8. The apparatus according to claim 1, wherein
the liquid contained in the container stored in the storage portion is supplied to a liquid discharge apparatus configured to perform a printing operation of discharging the liquid to a medium, and
the control unit is configured to:
acquire information indicating whether an execution instruction of the printing operation by a user exists, and
control the stirring operation after the resumption based on the acquired information.

9. The apparatus according to claim 8, wherein
if the acquired information indicates that the execution instruction of the printing operation exists, the control unit is configured to not perform the stirring operation after the resumption.

10. The apparatus according to claim 8, wherein
if the acquired information indicates that the execution instruction of the printing operation exists, the control unit makes the time of the stirring operation after the resumption shorter than in a case where the acquired information indicates that the execution instruction of the printing operation does not exist.

11. The apparatus according to claim 1, wherein
the control unit is configured to execute different processing concerning the resumption of the stirring operation based on whether the container stored in storage portion is extracted during the interruption of the stirring operation.

12. The apparatus according to claim 1, wherein
the control unit is configured to execute different processing concerning the resumption of the stirring operation based on whether the container stored in storage portion is exchanged with another container during the interruption of the stirring operation.

13. The apparatus according to claim 1, further comprising a storage detection unit configured to detect whether the container is stored in the storage portion.

14. The apparatus according to claim 1, further comprising a regulation detection unit configured to detect the state of the regulating unit.

15. The apparatus according to claim 1, wherein
the container placed on a tray is stored in the storage portion, and
the regulating unit is a mechanism configured to lock the tray to the storage portion in accordance with an operation of a user.

16. The apparatus according to claim 1, wherein
the container placed on a tray is stored in the storage portion, and
the regulating unit is a mechanism configured to lock a door for opening/closing the storage portion.

17. A stirring apparatus comprising:
a storage portion configured to store a container;
a stirring unit configured to perform a stirring operation for the container stored in the storage portion such that a liquid contained in the container is stirred; and
a notification unit configured to notify a user not to extract the container stored in the storage portion during the stirring operation.

18. A stirring apparatus comprising:
a storage portion configured to store a container;
a stirring unit configured to perform a stirring operation for the container stored in the storage portion such that a liquid contained in the container is stirred; and
a notification unit configured to perform a notification to a user to promote exchange of the container stored in the storage portion,
wherein the notification unit does not perform the notification during the stirring operation.

19. A stirring apparatus comprising:
a storage portion configured to store a container;
a stirring unit configured to perform a stirring operation for the container stored in the storage portion such that a liquid contained in the container is stirred;
a regulating unit whose state changes between a regulating state in which extraction of the container from the storage portion is regulated and a regulation cancel state; and
a notification unit configured, upon determining that the state of the regulating unit changes from the regulating state to the regulation cancel state during the stirring operation, notify a user to return the state of the regulating unit to the regulating state.
